(19) United States
(12) Patent Application Publication
(10) Pub. No.: US 2025/0128960 A1
(43) Pub. Date: Apr. 24, 2025

(54) A TARGET FOR MO-99 MANUFACTURE AND METHOD OF MANUFACTURING SUCH A TARGET

(71) Applicant: Australian Nuclear Science and Technology Organisation, Lucas Heights, New South Wales 2234 (AU)

(72) Inventors: Jessica Veliscek-Carolan, Lucas Heights (AU); Timothy Andrew Ablott, Lucas Heights (AU)

(21) Appl. No.: 18/835,586

(22) PCT Filed: Feb. 2, 2023
(86) PCT No.: PCT/AU2023/050068

§ 371 Date: Aug. 2, 2024

(30) Foreign Application Priority Data
Feb. 2, 2022 (WO) PCT/AU2022/050052

(51) Int. Cl. C01G 43/00; C01F 17/235; C01G 43/025; G21G 1/02

(52) U.S. Cl. CPC C01G 43/006; C01F 17/235; C01G 43/025; G21G 1/02; C01P 2002/85; C01P 2002/88; C01P 2004/03; C01P 2006/44; C04B 2235/3229

(57) ABSTRACT

A method of manufacturing particles of UO₂ for a porous matrix of a target for use in the manufacture of ⁹⁹Mo, comprising: infiltrating a solution of uranyl nitrate into a polymer template (62); either (i) introducing an alkali chemical to the uranyl nitrate infiltrated polymer template (64), causing precipitation of uranium oxide/hydroxide, and converting the uranium oxide/hydroxide to U₃O₈ (68) and concurrently removing the polymer template (70), by heating the infiltrated polymer template; or (ii) converting the uranyl nitrate to U₃O₈ (66) and concurrently removing the polymer template (74), by heating the infiltrated polymer template; and reducing the U₃O₈ to UO₂ via heating in a reducing atmosphere (72).

### RELATED APPLICATION

This application is based on and claims the benefit of the filing date of International Patent Application no. PCT/AU2022/050052, filed 2 Feb. 2022, the content of which as filed is incorporated herein by reference in its entirety.

### FIELD OF THE INVENTION

The invention relates to a target for the manufacture of ⁹⁹Mo (also referred to as Mo-99) and a method of manufacturing such a target, of particular but by no means exclusive application in maximizing efficiency and minimizing the production of unwanted by-products.

### BACKGROUND OF THE INVENTION

The radioisotope ⁹⁹Mo is produced for its decay product, ^{99m}Tc, which is of value in certain nuclear medicine diagnostic procedures. An existing method of producing ⁹⁹Mo involves the fission of ²³⁵U by neutron irradiation in a nuclear reactor. This method employs highly enriched uranium. (Natural uranium is approximately 0.71% ²³⁵U by mass, with a ²³⁵U to ²³⁸U [mass]ratio of approximately 0.0072; the term highly enriched uranium typically implies a ²³⁵U enrichment of greater than 20%.)

Enriched uranium targets of approximately 20% ²³⁵U enrichment are also employed for the manufacture of ⁹⁹Mo via the fission method, but the maximizing of ⁹⁹Mo output per unit time, in conjunction with the use of such targets, has led to increasing volumes of solid waste created from the dissolving of uranium targets. (Note that uranium with a ²³⁵U enrichment of approximately 20% may be described as low enriched uranium (LEU); the term “low enriched uranium” generally implies a ²³⁵U enrichment of greater than that of natural uranium but less than or equal to 20%.)

Reusable targets have been proposed but their realization has had a number of problems, including fission product build-up (which can lead to greater impurity levels), the incompatibility of targets with existing chemical extraction processes, the greater design and manufacture costs of reusable targets, and the presence of an extraction medium in the target (which could suffer degradation due to prolonged radiation damage, and give rise to complications when resealing and testing the target prior to re-irradiation).

Additionally, plutonium in the form of PuO₂ is a by-product of the irradiation of the ²³⁸U, which reduces efficiency and leads to waste that creates both proliferation and disposal concerns.

### SUMMARY OF THE INVENTION

It is an object of the present invention to provide a UO₂ target for use in the manufacture of ⁹⁹Mo, and a method of manufacturing such a target.

According to a first aspect of the invention, there is provided a UO₂ target for use in the manufacture of ⁹⁹Mo, the target comprising:
a porous matrix;
wherein the matrix comprises particles of UO₂ or of UO₂ and CeO₂ with a size of less than 7.15 μm; and
a molar ratio of ²³⁵U to Ce and ²³⁸U is less than 3%.

It should be appreciated that only ²³⁵U and ²³⁸U are considered in any detail in the present disclosure. Owing to the very small quantities of other isotopes (principally ²³⁴U) found in naturally occurring uranium, the presence of such isotopes is considered to fall within the precision as quoted herein of the parameters pertaining to the disclosed embodiments.

In a first particular embodiment, there is provided a UO₂ target for use in the manufacture of ⁹⁹Mo, the target comprising:
a porous matrix;
wherein the matrix comprises particles of UO₂ with a size (viz. mean diameter) of less than 7.15 μm (and, in an example, less than or equal to 7 μm, and in a further example 6±1 μm); and
the UO₂ comprises uranium with a ²³⁵U to ²³⁸U ratio of less than 3% ²³⁵U enrichment.

That is, the particles comprise UO₂ and the UO₂ comprises uranium with a ²³⁵U to ²³⁸U ratio of less than 3% ²³⁵U enrichment.

Thus, the target comprises UO₂, as UO₂ is impervious to the effects of the typical fluids used to extract the ⁹⁹Mo (such as super critical CO₂ or an alkaline chemical). For example, an alkaline solution can be passed through the matrix of UO₂ (to remove the ⁹⁹Mo), obviating the need to manage hydrogen gas. A porous matrix allows the produced ⁹⁹Mo to be more readily released and extracted, such by flushing the matrix or pores thereof with a solution in which ⁹⁹Mo is soluble.

Methods of extraction that may oxidize the target should be avoided, as conversion of a quantity of the UO₂ into U₃O₈ will compromise the target. To prevent oxidization, the target is desirably housed in a sealable target container to isolate it from the surrounding environment; optionally, the container may be backfilled with helium gas. The latter reduces oxidization (cf. the backfilling with helium of nuclear fuel rods), facilitate conduction of heat from the target and reduce the distance that the ejected ⁹⁹Mo travels.

A suitable sealable target container is advantageously thin-walled to maximize neutron transparency, has a valve and mesh filter at one or both ends, and a closure (such as a snap-fitting) at one or both ends. Suitable models for such a target container are anion exchange columns of the type provided by Hamilton Company of Reno, Nevada, U.S.A.

According to one aspect of the invention, there is provided a method of manufacturing the particles of UO₂ for the matrix, the method comprising:
(a) infiltrating a solution of uranyl nitrate into a polymer template (such as of polyacrylonitrile or ‘PAN’);
(b) either (i) introducing an alkali chemical to the uranyl nitrate infiltrated polymer template, causing precipitation of uranium oxide/hydroxide, and converting the uranium oxide/hydroxide to U₃O₈ and concurrently removing the polymer template by heating the infiltrated polymer template (for example in air or a noble gas); or (ii) converting the uranyl nitrate to U₃O₈ and concurrently removing the polymer template by heating the infiltrated polymer template (for example in air or a noble gas); and
(c) reducing the U₃O₈ to UO₂ via heating in a reducing atmosphere (such as 3.5% hydrogen in nitrogen gas).

The polymer template may be in the form of PAN beads.

Herein, reference to uranium oxide/hydroxide is intended to refer to a mixture of uranium oxide and uranium hydroxide. Likewise, reference to cerium oxide/hydroxide is intended to refer to a mixture of cerium oxide and cerium hydroxide. The ratios will depend on the application, but in many cases the mixture may contain more of the oxide than of the hydroxide.

The polymer template may thus be removed and the uranium oxide/hydroxide (or uranyl nitrate) infiltrated in the polymer template converted to U₃O₈ concurrently, preferably by heating the infiltrated polymer template to a maximum temperature of 400° C. or 600° C. (It is envisaged that, in some applications, still higher calcination temperatures may improve bead stability, but run the risk of reducing porosity.)

The reduction of the U₃O₈ to UO₂ is preferably at a maximum temperature of 1000° C.

Nitrate salts have the advantage of being highly soluble in water, which facilitates the uranyl nitrate's incorporation into the template (such as by soaking PAN in an aqueous solution of uranyl nitrate). If the template comprises beads, the beads desirably have a size (viz. mean diameter) selected to be—or to result in—the desired ultimate size of the particles. The solution of uranyl nitrate (or other precursor) comprises uranium with a ²³⁵U to ²³⁸U ratio of the desired ²³⁵U enrichment. The concentration of the solution and the volume infiltrated into the PAN beads are selected, in combination with the desired size of the particles, such that the final density of UO₂ in the matrix is the desired density.

The porous matrix may then be manufactured by, for example, sintering the particles of UO₂, or compressing the particles of UO₂ within a suitable container. In this and other target manufacturing methods of this invention, if a later step-such as sintering or compression-changes the volume or density of the particles or matrix, that change in volume or density should be taken into account and allowed for when manufacturing the particles and/or matrix, so that the target, once manufactured, has the desired characteristics.

In this and other aspects in which the polymer template is in the form of PAN beads, the beads may be manufactured according to the following method. The method involves preparing a (e.g. 5 wt %) solution of PAN in dimethyl sulfoxide (DMSO), pressurizing the PAN solution (such as in a CS-1560 Loctite (trade mark) pressure chamber using a HP-2.0, 2HDD air compressor), passing the PAN solution under pressure into a (e.g. PTFE) nozzle with needle outlets (in one example with 21 gauge needles of length 1-4 mm), and vibrating the nozzle so as to emit droplets of the PAN solution. The method may include controlling regularity of the droplets (which in due course constitute the beads) by controlling the period of vibration of the nozzle. The period of vibration of the nozzle can be monitored, such as with an oscilloscope.

The method includes collecting the droplets in a container (such as a beaker), advantageously containing water and a structure directing agent (such as Pluronic F127), resulting in formation of PAN beads. The beads are advantageously washed, such as with water, to remove the structure directing agent. This may involve washing until the washings are ˜pH 7, indicating removal of the Pluronic (trade mark) F-127.

The method then includes cross-linking the PAN beads (such as in petri dishes in an evaporation chamber). In one example, this step is performed with a controlled flow of air, temperature (e.g. ˜35° C.) and humidity (e.g. ˜45% RH), such as for 3 days. The method includes subsequently drying the beads (such as in air for 24 hours followed by under vacuum for 3 hours).

According to another aspect of the invention, there is provided a method of manufacturing the particles of UO₂ for the matrix by nanocasting or ‘repeat templating’, such as by creating a template comprising polymer beads, and infiltrating the beads with UO₂, and calcinating the infiltrated beads. The matrix can then be formed by sintering or compressing the calcinated beads.

In this alternative aspect, the method may optionally be controlled to provide the matrix with a hierarchical porosity, with pores that are progressively smaller (or the density progressively greater) from the centre of the matrix to the periphery of the matrix. In such a configuration, the matrix may be uniform in the axial direction, but have a hierarchical porosity radially. Desirably, the matrix at or constituting the peripheral walls of the target has a lower density than the average density, to facilitate ejection of ⁹⁹Mo from the particles and minimize the likelihood that the recoil distance for ejection of some of the ⁹⁹Mo will be excessive.

Hierarchical porosity can be achieved, for example, by dropping droplets of PAN solution (with their size controlled/regulated via oscillation) into water containing a surfactant, which causes the beads to form. The removal/evaporation of the solvent (e.g. water/DSMO) in the formed bead results in the macroporosity. The meso/micropores exist as interparticle meso/micropores when the UO₂ is introduced.

Thus, a porous matrix can be synthesized with a desired average density (as discussed above) and, optionally, hierarchical porosity.

The reusable uranium target makes use of the property of fission recoil whereby, when a fission occurs, the fission fragments have an initial energy that is dispersed via movement. The recoil energy (90 MeV) penetration range of ⁹⁹Mo is about 7.15 μm in UO₂ and 21.2 μm in H₂O so, if the UO₂ target has a particle size of 6±1 μm, the ⁹⁹Mo will be ejected into the surrounding target medium—provided there is enough distance between the uranium particles so that the ⁹⁹Mo does not implant itself into a neighbouring UO₂ particle. The ⁹⁹Mo can be chemically extracted from the target once the details of distribution of the UO₂ particles in the matrix, the minimum particle separation distance, the absorption of the matrix, the radiation properties, and the efficiency of ⁹⁹Mo extraction have been determined.

In principle, the UO₂ matrix could contain other materials, but it is generally advantageous (with a specific exception discussed below) that the matrix and the target contain little or no other materials, as these can complicate both the neutronics (i.e. neutron transport) and ⁹⁹Mo extraction. It will also be understood that the porosity of the target may have implications for the transfer from the target of the heat generated by neutron irradiation and the consequent nuclear fission and decay-such as reducing the ability of the heat to dissipate from the target (such as by conduction to a target cladding or to a heat transfer medium). However, this potential problem is ameliorated by the relatively low ²³⁵U enrichment of the target and/or intended irradiations times (of from 3 to 7 days). Indeed, it is envisaged that—in some examples—the heat will be just sufficient to at least partially reverse radiation damage (such that the target may be self-annealing to some degree and thereby reduce the risk or extent of pore collapse).

In one example, the matrix has an average density of less than or equal to 75% of the density of the UO₂ (viz. approximately 8.23 g/cm³, depending on the ²³⁵U enrichment).

The matrix is typically of approximately uniform average density.

The density of UO₂ per se is approximately 10.97 g/cm³, although this will vary to a small degree with ²³⁵U enrichment. The more porous the matrix (in this example with an average density of less than or equal to 75% of the density of UO₂), the easier the ⁹⁹Mo extraction, but this also reduces the total amount of ²³⁵U for any particular enrichment and target dimensions. Hence, the average density of the UO₂ matrix will generally be selected so as to provide sufficient total yield of ⁹⁹Mo and/or subsequently allow efficient ⁹⁹Mo extraction, in a manner that balances these considerations, in the context of available reactor time, waste minimization goal, ²³⁵U enrichment, ⁹⁹Mo demand and target dimensions.

In an example, the matrix has an average density of less than or equal to 65% of the density of the UO₂ (viz. approximately 7.13 g/cm³, depending on the ²³⁵U enrichment). In another example, the matrix has an average density of less than or equal to 55% of the density of the UO₂ (viz. approximately 6.03 g/cm³, depending on the ²³⁵U enrichment). In a further example, the matrix has an average density of less than or equal to 50% of the density of the UO₂ (viz. approximately 5.49 g/cm³, depending on the ²³⁵U enrichment). In a still further example, the matrix has an average density of less than or equal to 45% of the density of the UO₂ (viz. approximately 4.94 g/cm³, depending on the ²³⁵U enrichment).

In a particular example, the matrix has an average density of less than or equal to 40% of the density of the UO₂ (viz. approximately 4.39 g/cm³, depending on the ²³⁵U enrichment). In another example, the matrix has an average density of less than or equal to approximately 2.5 g/cm³. In an example, the matrix has an average density of approximately 2.5 g/cm³, and in another an average density of approximately 2.0 g/cm³.

A lower average density (e.g. between 50% and 70% of the density of the UO₂) may be advantageous in some applications in order to reduce waste, even at the expense of yield.

In an example, the average density is between 50% and 60% of the density of the UO₂.

The average density may be an initial average density (that is, before the first use of the target for the manufacture of ⁹⁹Mo).

It will be noted that depleted uranium may be employed. As will be appreciated, this may be less desirable in some applications, as—at lower ²³⁵U enrichments—yield will be reduced (all other parameters being equal). However, this effect can be at least somewhat compensated for by increasing average density.

In an example, the UO₂ comprises uranium with a ²³⁵U to ²³⁸U ratio of between 0.3% and 3% ²³⁵U enrichment (i.e. 0.3%<²³⁵U enrichment <3%). In an example, the UO₂ comprises uranium with a ²³⁵U to ²³⁸U ratio of between 0.5% and 3% ²³⁵U enrichment (i.e. 0.5%<²³⁵U enrichment <3%). In an example, the UO₂ comprises uranium with a ²³⁵U to ²³⁸U ratio of between 0.7% and 3% ²³⁵U enrichment (i.e. 0.7%<²³⁵U enrichment <3%). In an example, the uranium has a ²³⁵U enrichment of <2.8%. In an example, the uranium has a ²³⁵U enrichment of <2.5%, and in another example, the uranium has a ²³⁵U enrichment of <2%. In an example, the uranium has a ²³⁵U enrichment of <1.8%. In an example, the uranium has a ²³⁵U enrichment of <1.6%. In a certain example, the uranium has a ²³⁵U enrichment of <1.4% and in another <1.2%.

In certain example, the uranium has a ²³⁵U enrichment of >0.75%, and in another example, the uranium has a ²³⁵U enrichment of >0.8%. In still another example, the uranium has a ²³⁵U enrichment of >0.9%.

It should be understand that this particular embodiment also includes examples with any combination of these upper and lower ²³⁵U enrichments. For example, examples with the following ²³⁵U enrichments are envisaged:

| | | |
|---|---|---|
| 0.3% < ²³⁵U enrichment < 3% | 0.8% < ²³⁵U enrichment < 2.5% | 0.75% < ²³⁵U enrichment < 1.6% |
| 0.3% < ²³⁵U enrichment < 2% | 0.9% < ²³⁵U enrichment < 2.5% | 0.8% < ²³⁵U enrichment < 1.6% |
| 0.75% < ²³⁵U enrichment < 3% | 0.7% < ²³⁵U enrichment < 2% | 0.9% < ²³⁵U enrichment < 1.6% |
| 0.8% < ²³⁵U enrichment < 3% | 0.75% < ²³⁵U enrichment < 2% | 0.7% < ²³⁵U enrichment < 1.4% |
| 0.9% < ²³⁵U enrichment < 3% | 0.8% < ²³⁵U enrichment < 2% | 0.75% < ²³⁵U enrichment < 1.4% |
| 0.7% < ²³⁵U enrichment < 2.8% | 0.9% < ²³⁵U enrichment < 2% | 0.8% < ²³⁵U enrichment < 1.4% |
| 0.75% < ²³⁵U enrichment < 2.8% | 0.7% < ²³⁵U enrichment < 1.8% | 0.9% < ²³⁵U enrichment < 1.4% |
| 0.8% < ²³⁵U enrichment < 2.8% | 0.75% < ²³⁵U enrichment < 1.8% | 0.7% < ²³⁵U enrichment < 1.2% |
| 0.9% < ²³⁵U enrichment < 2.8% | 0.8% < ²³⁵U enrichment < 1.8% | 0.75% < ²³⁵U enrichment < 1.2% |
| 0.7% < ²³⁵U enrichment < 2.5% | 0.9% < ²³⁵U enrichment < 1.8% | 0.8% < ²³⁵U enrichment < 1.2% |
| 0.75% < ²³⁵U enrichment < 2.5% | 0.7% < ²³⁵U enrichment < 1.6% | 0.9% < ²³⁵U enrichment < 1.2% |

In an example, the uranium has a ²³⁵U enrichment of approximately 1%.

The ²³⁵U to ²³⁸U ratio may be an initial ²³⁵U to ²³⁸U ratio (that is, before the first use of the target for the manufacture of ⁹⁹Mo).

In an example, the target is configured to yield a maximum amount of ⁹⁹Mo and a maximum amount of burnup from a lowest initial amount of ²³⁵U, thus minimizing ²³⁵U waste.

In an example, the target is configured to maximize a sustainability index S_{targ}, where:

$${S}_{targ} = \frac{{A}_{T}^{2}}{{}_{}^{235} {U}_{T}^{} \cdot {}_{}^{235} {U}_{b}^{}} ( {Bq}^{2} \cdot {g}^{- 2} ) ,$$

where A_{T} is a predefined amount of ⁹⁹Mo desired to be produced in the irradiation, ²³⁵U_{T} is the total amount of ²³⁵U in the target before the irradiation, and ²³⁵U_{b} is the amount of ²³⁵U burned up in the irradiation. The parameters ²³⁵U_{T} and ²³⁵U_{b} may be established empirically or by modelling, such as before or after the irradiation. Though principally intended for a single irradiation, this relationship is also valid for plural irradiations—in which case A_{T} would represent the total desired ⁹⁹Mo yield, ²³⁵U_{T} is the total amount of ²³⁵U in the target before the first irradiation and ²³⁵U_{b} the total amount of ²³⁵U burned up in all of the irradiations. Extensive modelling has shown that a change in volume does not substantially affect sustainability, such that volume changes—if any—could be neglected in the analysis of target performance.

The sustainability index S_{targ} for one or more (n≥1) irradiations may alternatively be expressed as:

$${S}_{targ} = {\sum }_{i = 1}^{n} \frac{{A}_{Ti}^{2}}{{}_{}^{235} {U}_{Ti}^{} \cdot {}_{}^{235} {U}_{bi}^{}} ( {Bq}^{2} \cdot {g}^{- 2} ) ,$$

where A_{Ti} is the ⁹⁹Mo yield of the i-th irradiation, ²³⁵U_{Ti} is the amount of ²³⁵U in the target before the i-th irradiation (or equivalently the amount of ²³⁵U in the target after the (i−1)-th irradiation, when i>1), and ²³⁵U_{bi} is the amount of ²³⁵U burned up in the i-th irradiation.

The UO₂ target may be of any suitable dimensions, but is typically of a size dictated by the dimensions of the core of the reactor that is to be used to irradiate the target, including being able to fit the irradiation position or target holder within the reactor. For example, the height of the target is, in one example, less than or equal to the height of the core. That is, if the reactor core has a height of height of 60 cm, the target may be sized with a height of less than or equal to 60 cm.

As mentioned above, the UO₂ matrix may contain other materials, provided they do not unduly complicate the neutronics or the ⁹⁹Mo extraction. However, the target may be doped with one or more minor actinides in order to reduce proliferation concerns arising from ²³⁹Pu build-up (see Peryoga et al., (2005)). Suitable dopants (e.g. ²³⁷Np or a mixture of Np, Am and Cm) and amounts of doping (e.g. approximately 1% by mole relative to the ²³⁵U content) may be ascertained from Peryoga et al. (2005), which is incorporated herein by reference.

A major further example of the inclusion of another material arises from the fact that the crystal structures of cerium(IV) oxide (CeO₂, also referred to as cerium dioxide or ceria) and UO₂ are similar, as are their molar densities. Hence, CeO₂ may be—in effect—substituted for at least some of the ²³⁸UO₂. In principle, CeO₂ may be substituted for substantially all of the ²³⁸UO₂ (such that the particles comprise essentially only ²³⁵UO₂ and CeO₂, with possibly trace amounts of ²³⁸UO₂), but it is expected that this would be needlessly or prohibitively expensive.

Thus, according to a second particular embodiment of this aspect of the invention, there is provided a UO₂ target for use in the manufacture of ⁹⁹Mo, the target comprising:
a porous matrix;
wherein the matrix comprises particles that comprise UO₂ and CeO₂, the particles having a size (viz. mean diameter) of less than 7.15 μm (and, in an embodiment, less than or equal to 7 μm, and in a further embodiment 6±1 μm); and
the molar ratio of ²³⁵U to Ce and ²³⁸U (that is

$$\frac{n ( {}_{}^{235} {U}^{} )}{n ( Ce ) + n ( {}_{}^{238} {U}^{} )} ,$$

where n represents the number of moles) is less than 3%.

Generally, the matrix comprises enriched UO₂ mixed with CeO₂, in which the UO₂ comprises uranium with a ²³⁵U to ²³⁸U ratio of less than or equal to 20% ²³⁵U enrichment (viz. low enriched uranium), but higher enrichments are possible and contemplated in order to further minimize the ²³⁸U content of the target. As mentioned above, the matrix may comprise ²³⁵UO₂ and CeO₂ only, but it may not be convenient or possible to obtain pure ²³⁵UO₂. Even if ²³⁵UO₂ is available, it may be more cost-effective to use a matrix that comprises ²³⁵UO₂ or highly enriched UO₂ mixed with natural UO₂ and CeO₂.

In certain examples, the molar ratio of ²³⁵U to Ce and ²³⁸U is between 0.3% and 3%, or between 0.5% and 3%, or between 0.7% and 3%, or between 0.75% and 2.8%, or between 0.8% and 2.0%, or between 0.9% and 1.4%.

In a particular example, the molar ratio of ²³⁵U to Ce and ²³⁸U is approximately 1%. If the molar ratio of U:Ce is 50%, this example corresponds to a UO₂ feedstock with an ²³⁵U enrichment of approximately 2%.

In another example, the matrix comprises 50% UO₂ and 50% CeO₂ by mass, wherein the UO₂ comprises uranium with a ²³⁵U enrichment of between 1.5% and 5.6%, or of between 1.6% and 4.0%, or of between 1.8% and 2.8%, or of approximately 2%. In these examples, therefore, the matrix comprises, respectively, between 0.75% and 2.8% ²³⁵UO₂, between 0.8% and 2.0% ²³⁵UO₂, between 0.9% and 1.4% ²³⁵UO₂, and approximately 1% ²³⁵UO₂, by mass (ignoring trace amounts of ²³⁴UO₂).

In each example of this particular embodiment, the CeO₂ typically comprises natural Ce. Natural Ce is predominantly (88.4%) ¹⁴⁰Ce, so CeO₂ comprising natural Ce is generally the least expensive form of CeO₂. It will be appreciated, however, that other isotopes of Ce may be used, especially one or more of the naturally occurring isotopes.

The second particular embodiment shares the advantages of the first particular embodiment. In addition, a number of advantages arise from the use of cerium in this manner. For example, this particular embodiment effectively substitutes cerium for at least some of the ²³⁸U, and the thermal neutron absorption cross section of natural Ce is 0.63 barns whereas the thermal neutron absorption cross section of ²³⁸U is 2.68 barns. Hence, the production of plutonium in the form of PuO₂ (from the irradiation of the ²³⁸U) can be substantially reduced. This also leads to greater efficiency, as fewer neutrons will be absorbed by the target so fewer neutrons are required in the production of ⁹⁹Mo. (For example, it has been found that, when there are no Mo plates in the Australian Nuclear Science and Technology Organisation's OPAL reactor, the reactor uses 5% more fuel. This is because the Mo plates comprise LEU so generate their own neutron flux, in essence acting like fuel.)

The target of the second particular embodiment behaves much as does the target of the first particular embodiment, so each of the optional features disclosed above in the context of the first particular embodiment are likewise optional features of the second particular embodiment, though with CeO₂ substituted for at least some of the ²³⁸UO₂ of the first particular embodiment and with consequent adjustment of various parameters as required.

In certain examples of the second particular embodiment, the matrix has a porosity such that an average density of the matrix is less than or equal to 50% of the density of the UO₂ and CeO₂ content.

Cerium dioxide (if comprising natural cerium) has a density of approximately 7.215 g/cm³ whereas, as mentioned above, the density of UO₂ depends on its ²³⁵U enrichment; with the naturally occurring isotopic abundances, density of UO₂ is approximately 10.97 g/cm³. (The densities of ²³⁵UO₂ and ²³⁸UO₂ are approximately 10.850 g/cm³ and 10.972 g/cm³ respectively.) Consequently, in an example in which the matrix comprises essentially only ²³⁵UO₂ and CeO₂, with a molar ratio of ²³⁵U to Ce of just under 3%, the UO₂ and CeO₂ content has an average density of approximately 7.32 g/cm³. Hence, an average density of the matrix of less than or equal to 50% of the density of the UO₂ and CeO₂ content equates to an average density of less than or equal to approximately 3.66 g/cm³.

In another example, the matrix has a porosity such that an average density of the matrix is less than or equal to 50% of the density of the UO₂ and CeO₂ content, but non-²³⁵UO₂ content has a molar ratio of 50% ²³⁸UO₂ and 50% CeO₂, again with a molar ratio of ²³⁵U to Ce and ²³⁸U of just under 3%. CeO₂ has a density of about 41.9 mmol/cm³, and ²³⁸UO₂ a density of about 40.6 mmol/cm³, so the density of the combined CeO₂ and ²³⁸UO₂ is approximately 41.25 mmol/cm³, implying a density of ²³⁵UO₂ of approximately 1.256 mmol/cm³.

The particles, porous matrix and target of this particular embodiment may be manufactured as described above in the context of the first particular embodiment of the first aspect of the invention, varied to incorporate the CeO₂, such that—in effect—some of the UO₂ is replaced with CeO₂ and the resulting matrix comprises a desired molar ratio of ²³⁵U to Ce and ²³⁸U. According to another aspect of the invention, there is provided a method of manufacturing the particles, comprising:
(a) infiltrating a solution of a cerium salt (such as cerium nitrate) into a first polymer template (such as PAN beads);
(b) infiltrating a solution of uranyl nitrate into a second polymer template (such as PAN beads);
(c) either (i) introducing an alkali chemical to the infiltrated first polymer template, causing precipitation of cerium oxide/hydroxide; and converting the cerium oxide/hydroxide to CeO₂ and concurrently removing the first polymer template by heating the infiltrated first polymer template (for example in air or a noble gas); or (ii) converting the cerium salt to CeO₂ and concurrently removing the first polymer template by heating the infiltrated first polymer template (for example in air or a noble gas);
(d) either (i) introducing an alkali chemical to the uranyl nitrate infiltrated second polymer template, causing precipitation of uranium oxide/hydroxide; and converting the uranium oxide/hydroxide to U₃O₈ and concurrently removing the second polymer template by heating the infiltrated second polymer template (for example in air or a noble gas); or (ii) converting the uranyl nitrate to U₃O₈ and concurrently removing the second polymer template by heating the infiltrated second polymer template (for example in air or a noble gas); and
(e) reducing the U₃O₈ to UO₂ via heating in a reducing atmosphere (such as 3.5% hydrogen in nitrogen gas).

In one example, this method comprises forming the particles of UO₂ and the particles of CeO₂ sequentially, in which case the method results in two sets of particles (those comprising UO₂ and those comprising CeO₂) which are then mixed.

The particles (whether one or two sets) are formed into the porous matrix by, for example, sintering the particles, or compressing the mixed sets of particles within a suitable container. Again, to prevent oxidization, the target is desirably housed in a sealable target container, optionally backfilled with helium gas.

The ratio of cerium and uranium can be controlled as desired, such as by controlling the ratio of the sizes of the first and second sets of particles, and/or by controlling the amount or amounts of infiltration of the cerium salt and uranyl nitrate.

If the template comprises PAN beads, the beads are selected to have a size (viz. mean diameter) to be or result in the desired size of the particles, and the solution or solutions having a concentration or concentrations and a volume or volumes such that the resulting matrix comprises a desired molar ratio of ²³⁵U to Ce and ²³⁸U and, in combination with the desired size of the particles, such that the final density of UO₂ in the matrix is a desired density.

According to another aspect of the invention, there is provided a method of manufacturing particles of UO₂ and CeO₂ for a porous matrix of a target for use in the manufacture of ⁹⁹Mo, the method comprising:
infiltrating a solution of uranyl nitrate and cerium nitrate into a polymer template (such as of PAN, e.g. as PAN beads);
precipitating uranium oxide and uranium hydroxide and cerium oxide and cerium hydroxide by introducing an alkali chemical (such as gaseous ammonia) to the uranyl nitrate and cerium nitrate infiltrated template;
converting the uranium oxide and uranium hydroxide, and cerium oxide and cerium hydroxide, to U₃O₈ and CeO₂ respectively and concurrently removing the template, by heating the infiltrated template; and
reducing the U₃O₈ and CeO₂ to UₓCe₁₋ₓO₂ via heating in a reducing atmosphere (such as hydrogen (e.g. 3.5%) in nitrogen gas), where x is the initial molar mixing ratio of uranium and cerium.

Subsequently, the size of the particles will depend on (and be controlled by) for how long and/or at how high a temperature sintering is performed when forming the porous matrix.

According to another aspect of the invention, there is provided a method of manufacturing, comprising nanocasting or ‘repeat templating’, such as by creating a template comprising polymer (e.g. PAN) beads and infiltrating the beads with cerium and uranium (as described above), and calcinating the infiltrated beads. The matrix can then be formed by sintering or compressing the calcinated beads. Optionally, the method may be controlled to provide the target with a hierarchical porosity, as described above, wherein meso/micropores exist as interparticle meso/micropores when UO₂ and/or Ce is introduced.

The cerium for infiltration may be in any suitable form, such as a cerium salt (e.g. cerium(III) nitrate (Ce(NO₃)₃), cerium(III) oxalate (Ce₂(C₂O₄)₃), or cerium(III) acetylacetonate (Ce(C₅H₇O₂)₃(H₂O)ₓ)). As mentioned above, nitrate salts are highly soluble in water, which facilitates cerium nitrate's incorporation into the template (such as by soaking PAN in an aqueous solution of uranyl nitrate and cerium nitrate).

The ratio of infiltrated cerium and uranium and the enrichment of the uranium (in whatever form is employed) are selected to provide the desired ultimate molar ratio of ²³⁵U to Ce and ²³⁸U.

Targets according to this particular embodiment may also be doped with one or more minor actinides (e.g. ²³⁷Np or a mixture of Np, Am and Cm) in order to reduce proliferation concerns. Suitable dopants (e.g. ²³⁷Np or a mixture of Np, Am and Cm) and amounts of doping (e.g. approximately 1% by mole relative to the ²³⁵U content) may be ascertained from Peryoga et al. (2005).

According to a second aspect of the invention, there is provided a method of producing ⁹⁹Mo (or use of a UO₂ target to produce ⁹⁹Mo), the method comprising:
(a) irradiating a UO₂ target according to the first aspect of the invention with thermal neutrons, with an irradiation time of between 3 and 7 days; then
(b) extracting ⁹⁹Mo from the target (such as by UAlₓ extraction);
wherein the method includes performing steps (a) and (b) 2 or more times.

In an embodiment, the method includes a delay between an instance of step (a) and a next instance of step (a) (such as before and/or after step (b)), sufficient to allow—in combination with the time required to perform step (b)—one or more by-products (such as ¹³⁵Xe) in the target to decay to a predefined level. In one example, the predefined level is less than 50% of the amount of a specified by-product (e.g. ¹³⁵Xe) present at the end of step (a). In another example, the predefined level is less than 25% of the amount of a specified by-product present at the end of step (a), and in another less than 12.5% of the amount of a specified by-product present at the end of step (a).

As mentioned above, the relatively short irradiation time has the advantage of minimizing target heating and hence the risk of target damage. In addition, this effect—as well as the low ²³⁵U enrichment—reduces the production or build-up of the by-product, ¹³⁵Xe. As will be appreciated by the skilled person in this field, ¹³⁵Xe has a much higher neutron absorption cross-section than does ²³⁵U, so reduces the neutron flux available for the production of manufacture ⁹⁹Mo. Short irradiation times minimize ¹³⁵Xe build-up and, as ¹³⁵Xe has a half-life of 9.1 h, the time required to extract the ⁹⁹Mo from the target (and any further optional delay) allows time for significant ¹³⁵Xe decay (as well as decay of its daughter, ¹³⁵Cs).

In one embodiment, the method includes performing steps (a) and (b) 3 or more times. In another embodiment, the method includes performing steps (a) and (b) 4 or more times. In still another embodiment, the method includes performing steps (a) and (b) 2 to 6 times.

In a further embodiment, the method includes performing steps (a) and (b) 3 to 5 times (i.e. the target is re-irradiated and re-processed to extract ⁹⁹Mo—after a first irradiation and processing—2 to 4 times).

Generally, the maximum number of times the target is irradiated and the ⁹⁹Mo yield extracted depends on how many times the target can be profitably used. This maximum may correspond to the ⁹⁹Mo yield's becoming too low to justify the expense of operating the reactor, and/or to justify the expense of performing ⁹⁹Mo extraction, and/or to justify the waste generated by the method, and/or to satisfy ⁹⁹Mo demand/requirements.

In an embodiment, the irradiation time is between 4 and 6 days. In one embodiment, the irradiation time is between 4.5 and 5.5 days. In a particular embodiment, the irradiation time is approximately 5 days.

The irradiation may be performed with, for example, a nuclear reactor that includes a heavy water reflector vessel with a UO₂ core (e.g. a reflector vessel with a diameter of 200 cm and a height of 120 cm, and a UO₂ core with a diameter of 30 cm and a height of 60 cm).

It should be noted that any of the various features of each of the above aspects of the invention and of the embodiments detailed below can be included or combined, as suitable and desired, in each of those aspects.

### BRIEF DESCRIPTION OF THE DRAWING

In order that the invention be better understood, embodiments will now be described, by way of example, with reference to the accompanying drawing in which:

FIG. 1 is a schematic view of a reactor model used to model the performance of a reusable target;

FIG. 2 is a schematic view of the reactor model of FIG. 1 with a reusable target;

FIG. 3 is a plot of effective neutron multiplication factor, k_{eff}, versus core UO₂ core density, as simulated for the reactor model of FIG. 1;

FIG. 4 is a plot of ⁹⁹Mo, ⁹⁵Zr, ¹³³Xe, ¹³¹I and ¹³⁵Xe yield versus reusable UO₂ target density, as simulated for the reactor and target models of FIG. 2, using a 20% ²³⁵U enriched target and a 2 day irradiation;

FIG. 5 is a plot of ⁹⁹Mo, ⁹⁵Zr, ³³Xe, ¹³¹I and ¹³⁵Xe yield versus reusable UO₂ target density, as simulated for the reactor and target models of FIG. 2, using a 20% ²³⁵U enriched target and a 5 day irradiation;

FIG. 6 is a plot of ⁹⁹Mo, ⁹⁵Zr, ³³Xe, ¹³¹I and ¹³⁵Xe yield versus reusable UO₂ target density, as simulated for the reactor and target models of FIG. 2, using a 20% ²³⁵U enriched target and a 10 day irradiation;

FIG. 7 is a plot of ⁹⁹Mo, ⁹⁵Zr, ¹³³Xe, ¹³¹I and ¹³⁵Xe yield versus reusable UO₂ target density, as simulated for the reactor and target models of FIG. 2, using a 1% ²³⁵U enriched target and a 2 day irradiation;

FIG. 8 is a plot of ⁹⁹Mo, ⁹⁵Zr, ³³Xe, ¹³¹I and ¹³⁵Xe yield versus reusable UO₂ target density, as simulated for the reactor and target models of FIG. 2, using a 1% ²³⁵U enriched target and a 5 day irradiation;

FIG. 9 is a plot of ⁹⁹Mo, ⁹⁵Zr, ¹³³Xe, ¹³¹I and ¹³⁵Xe yield versus reusable UO₂ target density, as simulated for the reactor and target models of FIG. 2, using a 1% ²³⁵U enriched target and a 10 day irradiation;

FIG. 10 is a plot of ⁹⁹Mo production target efficiency ε_{targ} versus UO₂ target density, for a 20% ²³⁵U enriched target and a 1% ²³⁵U enriched target and 2, 5 and 10 day irradiations, derived from the plots of FIGS. 4 to 9;

FIG. 11 is a plot of ²³⁵U percentage burnup versus UO₂ target density, for a 20% ²³⁵U enriched target in the configuration of FIG. 2, for various irradiations;

FIG. 12 is a plot of ²³⁵U percentage burnup versus UO₂ target density, for a 1% ²³⁵U enriched target in the configuration of FIG. 2, for various irradiations;

FIG. 13 is a three-dimensional plot of the modelled ⁹⁹Mo target total output (A_{T}) plotted versus UO₂ density (D) and versus irradiation time (t), for a 1% ²³⁵U enriched target in the configuration of FIG. 2;

FIG. 14 is a three-dimensional plot of the modelled ⁹⁹Mo target total output (A_{T}) plotted versus UO₂ density (D) and versus irradiation time (t), for a 3% ²³⁵U enriched target in the configuration of FIG. 2;

FIG. 15 is a three-dimensional plot of the modelled ⁹⁹Mo target total output (A_{T}) plotted versus UO₂ density (D) and versus irradiation time (t), for a 7% ²³⁵U enriched target in the configuration of FIG. 2;

FIG. 16 is a three-dimensional plot of the modelled ⁹⁹Mo target total output (A_{T}) plotted versus UO₂ density (D) and versus irradiation time (t), for a 10% ²³⁵U enriched target in the configuration of FIG. 2;

FIGS. 17A and 17B are three- and two-dimensional plots respectively of the modelled sustainability index (S_{targ}) plotted versus UO₂ density (D) and versus irradiation time (t), for a 1% ²³⁵U enriched target in the configuration of FIG. 2;

FIGS. 18A and 18B are three- and two-dimensional plots respectively of the modelled sustainability index (S_{targ}) plotted versus UO₂ density (D) and versus irradiation time (t), for a 3% ²³⁵U enriched target in the configuration of FIG. 2;

FIGS. 19A and 19B are three- and two-dimensional plots respectively of the modelled sustainability index (S_{targ}) plotted versus UO₂ density (D) and versus irradiation time (t), for a 7% ²³⁵LU enriched target in the configuration of FIG. 2;

FIGS. 20A and 20B are three- and two-dimensional plots respectively of the modelled sustainability index (S_{targ}) plotted versus UO₂ density (D) and versus irradiation time (t), for a 10% ²³⁵U enriched target in the configuration of FIG. 2;

FIG. 21 is a plot of sustainability index (S_{targ}) versus initial UO₂ target volume (V), for 4, 5, 6 and 7 day irradiations and a target average density of 2 g/cm³, for a 1% ²³⁵U enriched target in the configuration of FIG. 2;

FIG. 22 is a plot, from the same simulation as that of FIG. 21, of total ⁹⁹Mo output (A_{T}) versus initial UO₂ target volume (V), for 4, 5, 6 and 7 day irradiations and a target average density of 2 g/cm³, for a 1% ²³⁵U enriched target in the configuration of FIG. 2;

FIG. 23A is a plot of modelled plutonium production Pu (mg) for an exemplary UO₂ target and various ²³⁵U/²³⁸U enrichments, a 6 day irradiation and a target density of 2.6 g/cm³, for a target in the configuration of FIG. 2;

FIG. 23B is a plot of modelled normalized plutonium production Pu for an exemplary UO₂ target and various target ²³⁵U/²³⁸U enrichments, shown both relative to enrichment and relative to ⁹⁹Mo production, normalized to plutonium production with 20% ²³⁵U enrichment, with a 6 day irradiation and a target density of 2.6 g/cm³, for a target in the configuration of FIG. 2;

FIG. 24A is a plot of a simulation of the stopping and range of 90 MeV ⁹⁹Mo ions in UO₂, modelled with SRIM (trade mark);

FIG. 24B is a plot of a simulation of the stopping and range of 90 MeV ⁹⁹Mo ions in CeO₂, modelled with SRIM;

FIG. 25 is a schematic view of the reactor model of FIG. 1 with a reusable UO₂ target that includes CeO₂, according to an embodiment of the present invention;

FIG. 26 is a plot of modelled plutonium production for exemplary UO₂ targets with 1% ²³⁵U, for various values of Ce content (%), the balance comprising ²³⁸U, for a 6 day irradiation and a target density of 2 g/cm³, for a UO₂/CeO₂ target in the arrangement of FIG. 24;

FIG. 27A is a flow diagram of a method of manufacturing particles of UO₂ for the porous matrix of a target for use in the manufacture of ⁹⁹Mo, according to an embodiment of the present invention;

FIG. 27B is a flow diagram of a method of manufacturing particles of UO₂ and particles of CeO₂ for the porous matrix of a target for use in the manufacture of ⁹⁹Mo, according to an embodiment of the present invention;

FIG. 27C is a flow diagram of a method of manufacturing particles of UO₂ and CeO₂ for the porous matrix of a target for use in the manufacture of ⁹⁹Mo, according to an embodiment of the present invention;

FIG. 28A is an TG-DSC trace obtained while heating CeO₂@PAN to 600° C. under an atmosphere of 20% O₂ in N₂ (compressed air);

FIG. 28B is an TG-DSC trace obtained while heating CeO₂@PAN to 600° C. under an Ar atmosphere;

FIGS. 29A and 29B are SEM images of fractured air-calcined CeO₂ beads after calcination at 400° C.;

FIGS. 30A and 30B are SEM images of two different pore locations within the air-calcined CeO₂ bead of FIG. 29A, exhibiting pore wall thicknesses of from ˜4 μm to ˜12 μm;

FIG. 31 is an SEM image of a fractured air-calcined UO₂ bead;

FIGS. 32A and 32B are SEM images of fractured Ar-calcined CeO₂ beads after calcination at 600° C.;

FIGS. 33A, 33B and 33C are SEM images of pore locations within a 600° C. Ar-calcined CeO₂ bead exhibiting pore wall thicknesses of from ˜1.5 μm to ˜2.9 μm;

FIGS. 34A and 34B are SEM images of pore locations within 800° C. Ar-calcined CeO₂ beads exhibiting pore wall thicknesses of from ˜2.2 μm to ˜3.5 μm;

FIGS. 35A, 35B, 35C and 35D are SEM images of pore locations within 1200° C. Ar-calcined CeO₂ beads exhibiting pore wall thicknesses of from ˜3.3 μm to ˜8.4 μm;

FIGS. 36A and 36B are SEM images of fractured Ar-calcined U_{0.05}Ce_{0.95}O₂ beads after calcination at 800° C.;

FIG. 37 is an EDS spectrum of a point within the material of the beads of FIGS. 36A and 36B; and

FIGS. 38A and 38B are plots of N₂ sorption isotherms at 77 K of CeO₂ heated at, respectively, 400° C. under air and 1200° C. under Ar.

### DETAILED DESCRIPTION OF EMBODIMENTS OF THE INVENTION

FIG. 1 is a schematic view of a simple reactor model 10 used to model the performance of a reusable target. The reactor model 10 includes a cylindrical heavy water reflector vessel 20, and a cylindrical UO₂ core 30 located at the centre of reflector vessel 20.

Reflector vessel 20 has a diameter of 200 cm and a height of 120 cm. UO₂ core 30 has a diameter of 30 cm and a height of 60 cm.

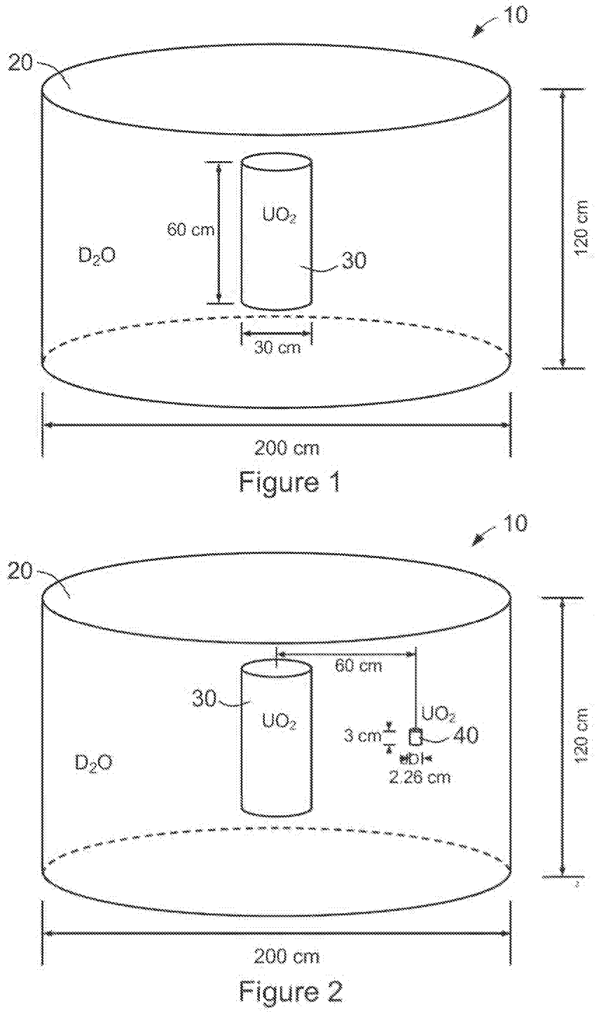

FIG. 2 is a schematic view of reactor model 10 of FIG. 1 with a (modelled) reusable target 40 (not shown to scale). Reusable target 40 is cylindrical, with a height of 3 cm, a radius of 1.13 cm and hence a volume of 12.03 cm³. Reusable target 40 was modelled as being located with its central axis 60 cm from and parallel to the central axis of UO₂ core 30, to simulate a potential position of a target rig in a reactor. This configuration was the basis of the following modelling and analysis, unless stated otherwise.

For reactor model 10 to simulate a practical reactor, the amount of uranium in UO₂ core 30 is adapted to allow a self-sustaining nuclear reaction. The sustainability of a nuclear reaction is given by the reactor's effective neutron multiplication factor, k_{eff}:

$${k}_{eff} = \frac{Rate of neutron production}{Rate of neutron absorption + rate of leakage}$$

where k_{eff}>1 indicates supercriticality: the number of neutrons produced by fission is greater than the number lost;
k_{eff}=1 indicates criticality: the number of neutrons produced by fission equals the number lost, the desired configuration for reactor operation; and
k_{eff}<1 indicates subcriticality: the number of neutrons produced by fission is less than the number lost.

To determine the density of UO₂ in UO₂ core 30 that will produce a k_{eff} of approximately 1, a number of different densities of UO₂ core 30 were modelled using the KCODE function in MCNP6 (trade mark), a Monte-Carlo radiation transport code that can be used to track different particle types over a broad range of energies and has user-definable variables such as geometries and timeframes.

Reactor model 10 was created with an initial value for k_{eff} of 1.0, and 5000 neutrons per cycle were generated. A total of 250 cycles were run, with data accumulation commencing after the first 50 cycles, resulting in approximately 200 million neutron collisions. These numbers were chosen to make the computing time practical.

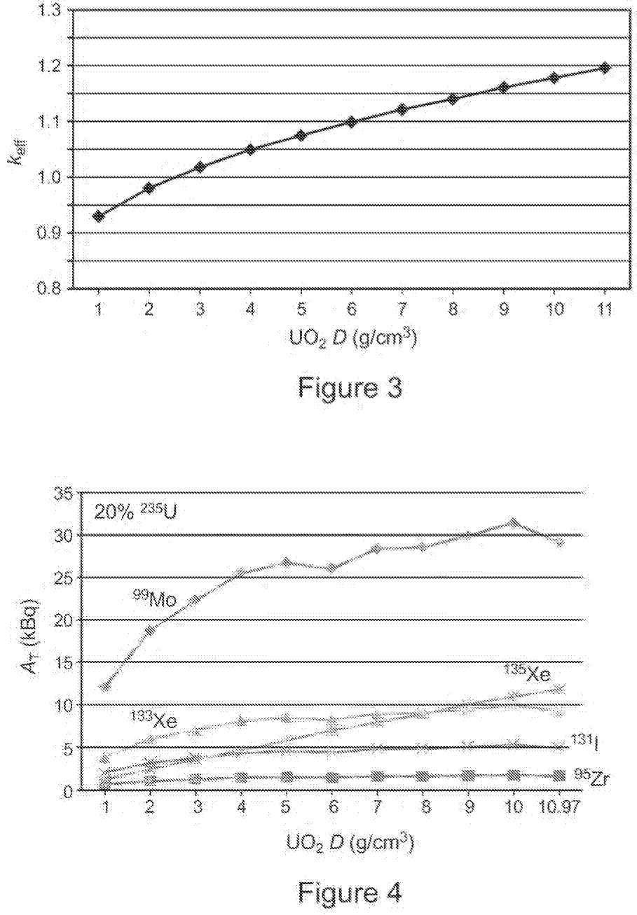

FIG. 3 shows the results, plotted as k_{eff} versus density (D) of UO₂ core 30 (in g/cm³). It was found that a UO₂ density of D=2.5 g/cm³ in UO₂ core 30 yielded a k_{eff} of ˜1 (viz. 0.99921 with a standard deviation of 0.00093, as determined by MCNP6). This value of D was then used when subsequently modelling reactor model 10 with reusable target 40 (cf. FIG. 2).

In order for ⁹⁹Mo to be ejected from the UO₂ particles in reusable target 40 and into the surrounding material, the density of the UO₂ needs to be adjusted downwards to allow for the presence of other materials or voids that will be used to contain the ⁹⁹Mo prior to chemical extraction. MCNP6 was used to model different UO₂ densities, with reactor model 10 at 20 MW and using the BURN function of MCNP6. When using the BURN function, the fission products produced are grouped into three tiers. Tier 1 includes the isotopes: ⁹³Zr, ⁹⁵Mo, ⁹⁹Tc, ¹⁰¹Ru, ¹³¹Xe, ¹³⁴Xe, ¹³³Cs, ¹³⁷Cs, ¹³⁸Ba, ¹⁴¹Pr, ¹⁴³Nd, 14⁵Nd. Tier 2 and tier 3 contain progressively more and more isotopes (which are listed in MCNP6 User's Manual). For calculation simplicity Tier 1 was used with the additional inclusion of ⁹⁹Mo and ¹³⁵Xe, as MCNP6 allows the addition of user-selected isotopes to the output. To compare the properties of targets with different ²³⁵U to ²³⁸U ratios, two types of targets were modelled using MCNP6: 20% enriched, and 1% enriched.

Firstly, reusable target 40 was modelled with a 20% ²³⁵U enrichment, as shown in Table 1:

TABLE 1
properties of 20% enriched reusable target

| | |
|---|---|
| Material | UO₂ |
| Density | variable |
| ²³⁵U Enrichment (%) | 20 |
| Shape | Cylindrical |
| Dimensions | Radius = 1.13 cm |
| | Height = 3 cm |
| | Volume = 12 cm³ |
| Distance from centre of reactor core | 60 cm |

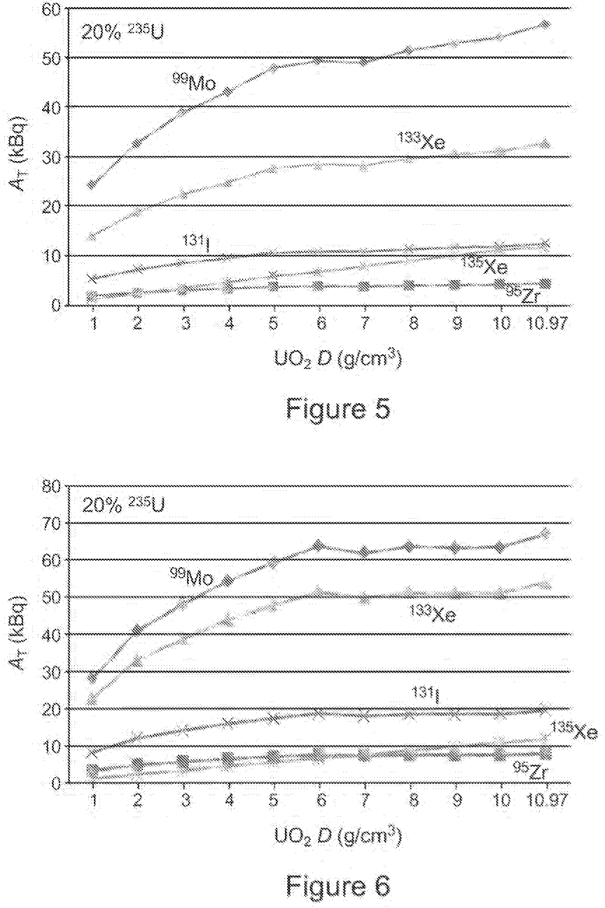

FIG. 4 is a plot of the results, shown as total ⁹⁹Mo yield or activity (A_{T}) in kBq versus UO₂ density (D) of reusable target 40 in g/cm³, for a 2 day irradiation. The yields of the next four most abundant radioactive products as given by MCNP6 (viz. ⁹⁵Zr, ³³Xe, ¹³¹I and ¹³⁵Xe) are also plotted. FIGS. 5 and 6 are comparable, but for 5 day and 10 day irradiations, respectively.

It will be noted from FIGS. 4 to 6 that the ⁹⁹Mo yield increases relatively linearly from a UO₂ density of 1 g/cm³ to approximately 5 to 6 g/cm³ and then appears to flatten out from 6 g/cm³ to the maximum density of 10.97 g/cm³ for all of the irradiation times. This suggests that, as the density of uranium increases, the ²³⁵U atoms become less accessible to the neutrons and the total number of fissions per ²³⁵U atom decreases. Thus, for 20% enriched targets, when considering waste minimization and yield maximization, target design would be optimized for a target density of approximately 5 to 6 g/cm³ of UO₂. When comparing the different irradiation times it can be seen that the yield increases with irradiation time: there was an approximately 100% increase in the activity with an increase in irradiation time from 2 days to 5 days and a further approximately 30% increase in activity with an increase from 5 days to 10 days irradiation time.

Secondly, reusable target 40 was modelled with a 1% ²³⁵U enrichment, as shown in Table 2:

TABLE 2
properties of 1% enriched reusable target

| | |
|---|---|
| Material | UO₂ |
| Density | variable |
| ²³⁵U Enrichment (%) | 1 |
| Shape | Cylindrical |
| Dimensions | Radius = 1.13 cm |
| | Height = 3 cm |
| | Volume = 12 cm³ |
| Distance from centre of reactor core | 60 cm |

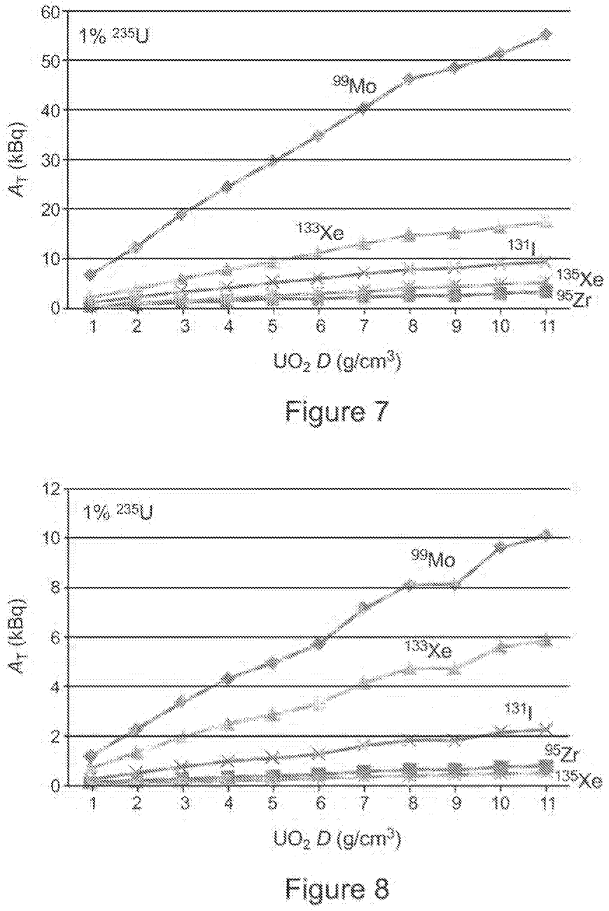

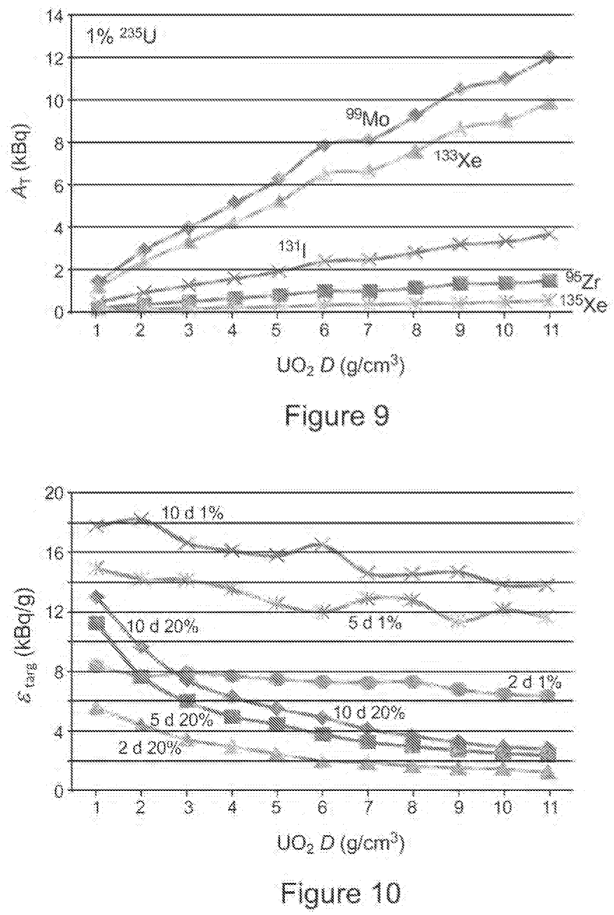

FIGS. 7 to 9 are plots of the results, again shown as total ⁹⁹Mo yield or activity (A_{T}) in kBq versus UO₂ density (D) of reusable target 40 in g/cm³, for 2 day, 5 day and 10 day irradiations, respectively. The yields of the next four most abundant radioactive products as given by MCNP6 (viz. ⁹⁵Zr, ¹³³Xe, ¹³¹I and ¹³⁵Xe) are again also plotted.

Compared with the 20% enriched target, the 1% enriched target had a relatively linear relationship between activity and density from 1 g/cm³ to 10.97 g/cm³, which is higher than that over the density range of 5 to 6 g/cm³ for the 20% enriched target—consistent with the idea that, as UO₂ density increases, the amount of fissioning that occurs per ²³⁵U atom decreases. Tables 3 compares the amount of ⁹⁹Mo produced with a UO₂ density of 6 g/cm³, with 20% ²³⁵U enrichment and 1% ²³⁵U enrichment respectively:

TABLE 3
Comparison of ⁹⁹Mo production with 20% and 1% enriched targets,
for 2, 5 and 10 day irradiations using MCNP6 modelling

| Irradiation time (days) | 20% enriched target yield (Bq) | 1% enriched target yield (Bq) | $\frac{20 \% enriched target yield}{1 \% enriched target yield}$ |
|---|---|---|---|
| 2 | 26048 | 3478 | 7.5 |
| 5 | 49284 | 5698 | 8.6 |
| 10 | 63751 | 7844 | 8.1 |

Hence, the amount of ⁹⁹Mo produced is only 7.5-8.6 times higher with the 20% enriched target as compared to the 1% enriched target, despite the fact that the amount of ²³⁵U in the 20% enriched target is 20 times greater than in the 1% enriched target. That is, when considering ⁹⁹Mo produced per quantity of ²³⁵U present in the target, the 1% enriched target was found to be 2.3-2.7 times more productive than the 20% target, according to the MCNP6 model used.

Another parameter to be considered in designing reusable target 40 is the amount of waste produced, which depends on the target efficiency. Target efficiency ε_{targ} can be expressed as the total activity of ⁹⁹Mo produced per total mass of ²³⁵U in the target:

$${ε}_{targ} = \frac{{}^{99} Mo produced ( Bq )}{{}_{}^{235} {U}^{} in target ( g )} = \frac{{A}_{T} ( {}^{99} Mo )}{{m}_{T} ( {}_{}^{235} U )}$$

Target efficiency ε_{targ} was thus calculated for both the 20% enriched UO₂ target and the 1% enriched UO₂ target, for 2, 5 and 10 day irradiations and with UO₂ densities ranging from 1 to 10.97 g/cm³. The results are plotted in FIG. 10, which shows that, the lower the UO₂ density, the more ⁹⁹Mo per gram of ²³⁵U is produced—implying greater target efficiency. Additionally, the efficiency increases by a greater amount at the lower density range and drops off a smaller amount with each increase in density. Increased irradiation time leads to a higher efficiency, but the increase in efficiency from 2 to 5 days irradiation is much larger than the increase from 5 to 10 days irradiation, which suggests that—from an efficiency point of view-targets with a low UO₂ density are preferable. When comparing the 20% enriched target with the 1% enriched target, the 1% enriched target outperforms the 20% enriched target in efficiency, with the 1% enriched target producing approximately 4.8-5.7 times the ⁹⁹Mo at a UO₂ density of 10.97 g/cm³ and 1.3-1.5 times the amount of ⁹⁹Mo at a UO₂ density of 1 g/cm³.

Another consideration in target design is the amount of ²³⁵U burnup, as burnup affects the waste produced and the number of times a target can be reused. Firstly, typical waste from fission based uranium targets is spent uranium containing an isotopic ratio of approximately 19.7% ²³⁵U/²³⁸U due to the 2-3% burnup for ⁹⁹Mo production. A target with a burnup greater than 2-3% thus implies reduced nuclear waste.

Secondly, as the amount of ²³⁵U reduces with target burnup (owing to the destruction of ²³⁵U atoms), the amount of ⁹⁹Mo produced with each subsequent irradiation is reduced. Eventually, ⁹⁹Mo production is too low to warrant an additional irradiation.

The burnup percentage of ²³⁵U in the 20% and 1% ²³⁵U targets was modelled for irradiations of 2 days, 5 days, 10 days, four×5 days and ten×5 days, for UO₂ densities ranging from 1 to 10.97 g/cm³ using the BURN function of MCNP6. The four×5 (=20) day and ten×5 day (=50) day irradiations were modelled to simulate a target being irradiated, ⁹⁹Mo extracted and the target re-irradiated multiple times, to obtain an indication of how times a target can be profitably reused.

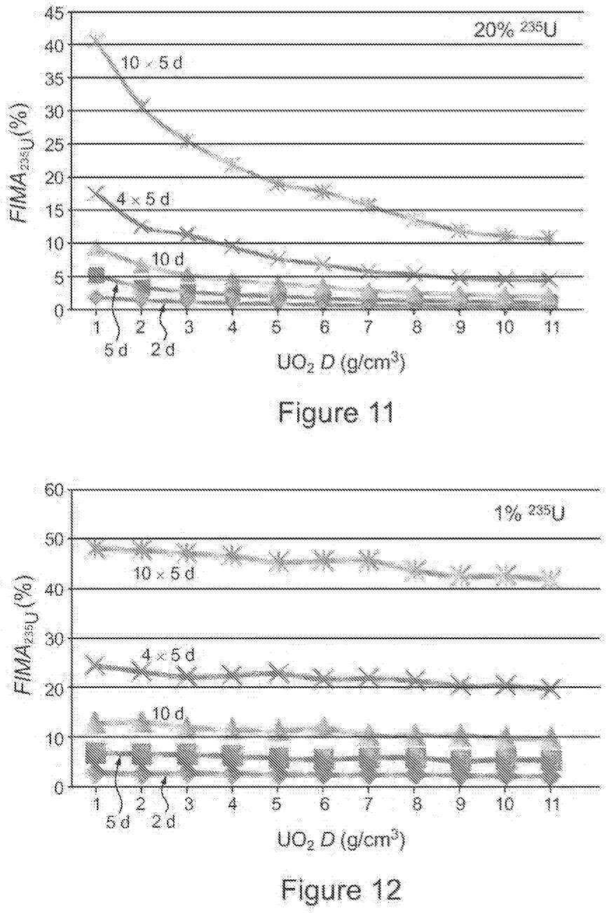

The results are shown in FIG. 11 (for 20% enrichment) and FIG. 12 (for 1% enrichment), plotted as burnup expressed as FIMA (i.e. fissions per initial metal atom) of ²³⁵U (%) versus UO₂ density D (g/cm³).

FIG. 11 shows that, with 20% ²³⁵U enrichment, ²³⁵U burnup increases rapidly as irradiation time increases and density decreases. This would indicate that a lower target density places limitations on the number of times a target can be reused for ⁹⁹Mo production with the 20% ²³⁵U target. FIG. 12 presents a slightly different picture, suggesting that—for a 1% ²³⁵U target—the burnup of ²³⁵U is linear over the density range 1 to 10.97 g/cm³. That is, the target's UO₂ density has little effect on burnup for a 1% ²³⁵U target. It may also be noted that, for all irradiation times, the burnup of the 20% ²³⁵U target is lower than that of the 1% ²³⁵U target. Furthermore, with 1% ²³⁵U enrichment and for low density targets (<5 g/cm³ UO₂), the burnup is not linear with irradiation time whilst for target densities above 5 g/cm³ UO₂ the burnup is approximately linear with irradiation time. This may suggest that lower density targets have an insufficient number of ²³⁵U atoms to undergo maximum fission as irradiation time increases and ²³⁵U atoms are ‘used up’.

These simulations suggest that, for high efficiency and reusability, reusable target 40 advantageously has these characteristics:
i) a target material comprising approximately 1% enriched UO₂,
ii) a UO₂ density as high as necessary to provide sufficient total yield and efficient 99Mo extraction (such as by UAlₓ extraction),
iii) an irradiation time of approximately 5 days, and
iv) intended target re-use (i.e. re-irradiation and re-processing) of approximately 2 to 4 times (that is, total target use of 3 to 5 times).

However, as the overall yield produced with this target design is lower than with a 20% enriched target, a balance must be struck between (a) efficiency and reusability, and (b) total yield, such as by suitable selection of target size and volume, ideally to approach the yield that can be obtained with a 20% enriched target.

To identify a suitable balance, the maximum output A_{T} produced per gram of ²³⁵U burned up was examined—which would allow ⁹⁹Mo producers to reduce the generation of nuclear waste.

Current methods of ⁹⁹Mo production are characterized by the formula:

$$Output = Total yield / Unit time$$

which is commonly expressed in GBq per week. When designing a target with this formula in mind it is understandable to pack as much ²³⁵U into the target as possible to ensure the maximum number of total fissions per unit time. In such cases, the ²³⁵U is in a state of saturation as there is significantly greater quantities present in the target than will ever fission. However, the efficiency of ⁹⁹Mo target 40 may be expressed as the amount of activity produced per gram of ²³⁵U burned up, or ²³⁵U_{b}, rather than—as discussed above—per gram of ²³⁵U initially in the target. Hence:

$$\begin{matrix}{ε}_{targ}^{′} = \frac{{}^{99} Mo produced ( Bq )}{{}_{}^{235} {U}_{b}^{} ( g )} \\ = \frac{{A}_{T} ( Bq )}{{}_{}^{235} {U}_{b}^{} ( g )} .\end{matrix}$$

A further parameter is then introduced to take into account the total output (A_{T}), a parameter termed ‘target quality’ or Q_{targ}, where:

$${Q}_{targ} = {ε}_{targ}^{′} \times {A}_{T} ( {Bq}^{2} \cdot {g}^{- 1} )$$

Thus, a target with a high Q_{targ} would produce the highest ⁹⁹Mo output for the most ²³⁵U burned. Next, it is desirable to consider the total amount of ²³⁵U originally in the target before irradiation, ²³³U_{T}, because the amount remaining in the target after the target's use should—all things being equal—be minimized, and the amount remaining is the difference between ²³⁵U_{T} and the ²³⁵U_{b}. Hence, a target sustainability index S_{targ} is proposed,

where:

$$\begin{matrix}{S}_{targ} = \frac{{ε}_{targ}^{′} \cdot {A}_{T}}{{}_{}^{235} {U}_{T}^{}} \\ = \frac{{Q}_{targ}}{{}_{}^{235} {U}_{b}^{}} \\ = \frac{{A}_{T}^{2}}{{}_{}^{235} {U}_{T}^{} \cdot {}_{}^{235} {U}_{b}^{}} ( {Bq}^{2} \cdot {g}^{- 2} )\end{matrix}$$

Hence, a reusable target 40 with high ⁹⁹Mo S_{targ} would produce the maximum output with the highest burnup from the lowest initial amount of ²³⁵U, thus minimizing ²³⁵U waste.

MCNP6 was again used to model both ²³⁵U burnup in grams and A_{T} of ⁹⁹Mo produced. The modelling was conducted with UO₂ target densities of 0.2 to 8 g/cm³ in 0.2 g/cm³ intervals, irradiation times of 2, 3, 4, 5, 6, 7, 8, 9, 10, 15 and 20 days, and target enrichments (% ²³⁵U/²³⁸U) of 1%, 3%, 7% and 10%.

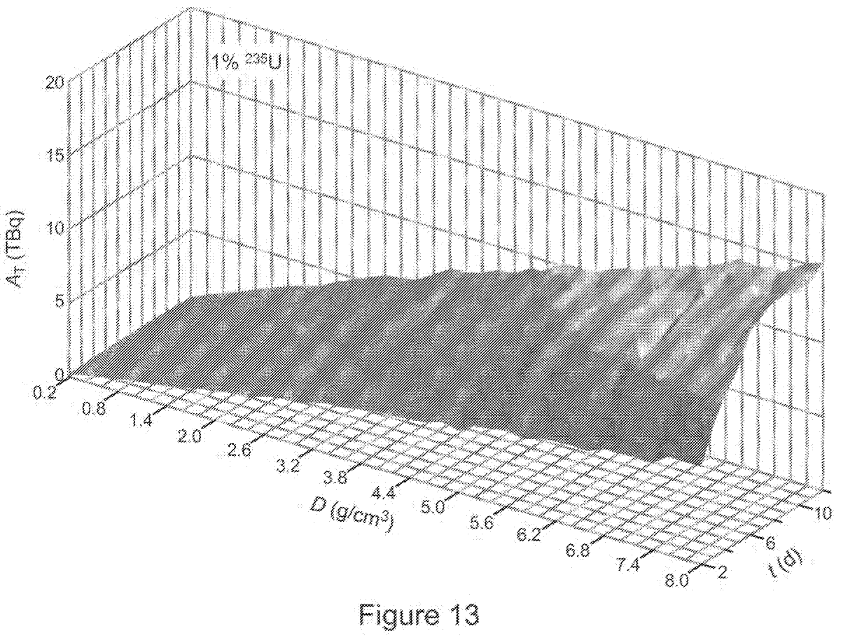

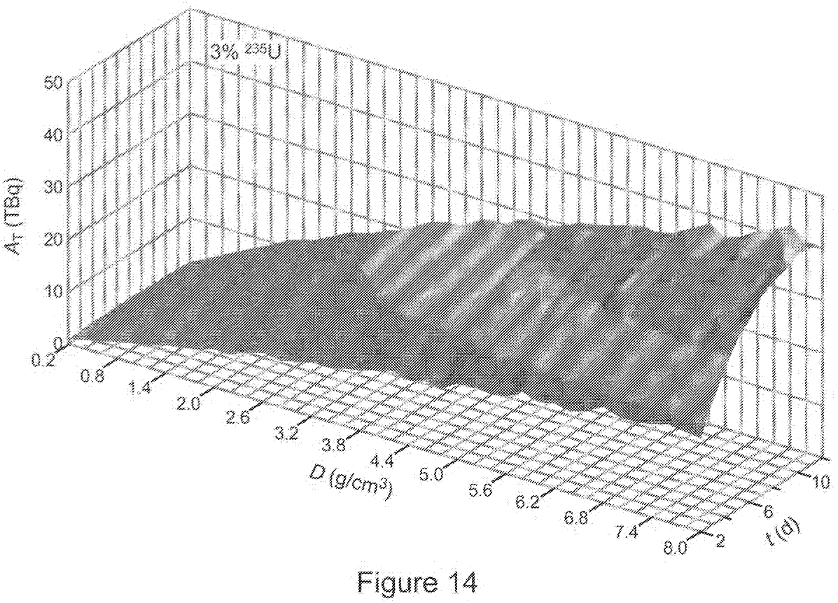

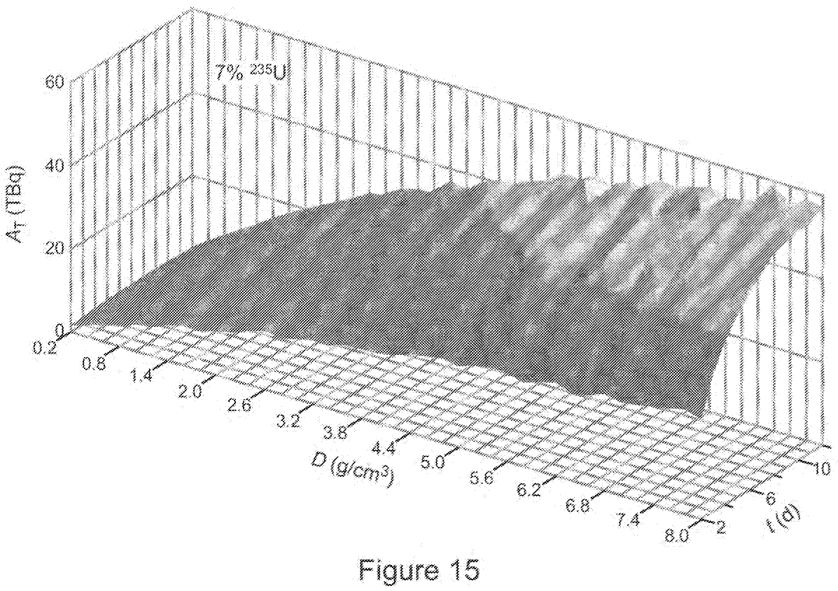

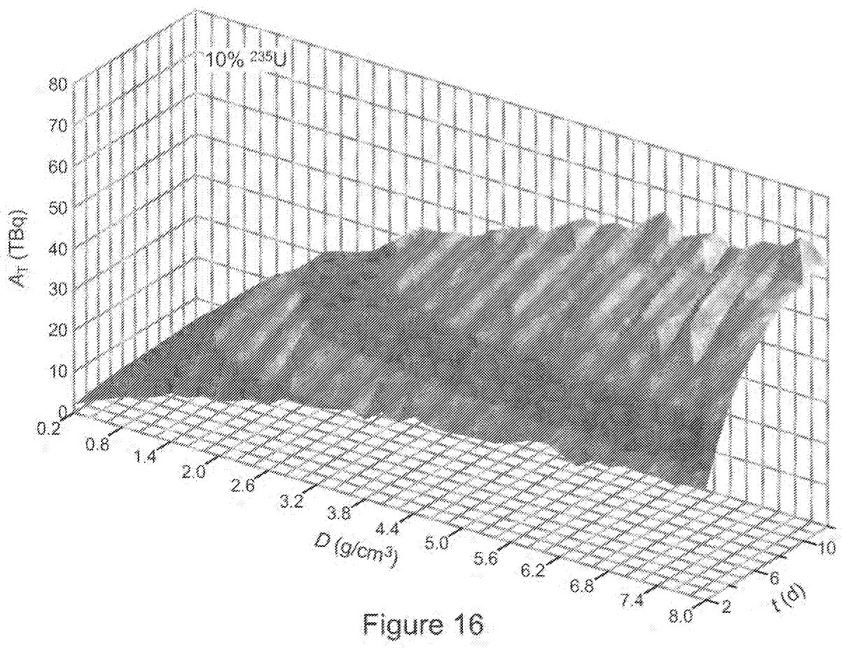

FIGS. 13 to 16 are plots of the results for, respectively, 1%, 3%, 7% and 10% ²³⁵U target enrichment. In these figures, 99Mo target total output (A_{T}) in TBq is plotted versus UO₂ density (D) in g/cm³ and versus irradiation time (t) in days. The results show maximum outputs around highest UO₂ density and longest irradiation time—the focus of existing techniques.

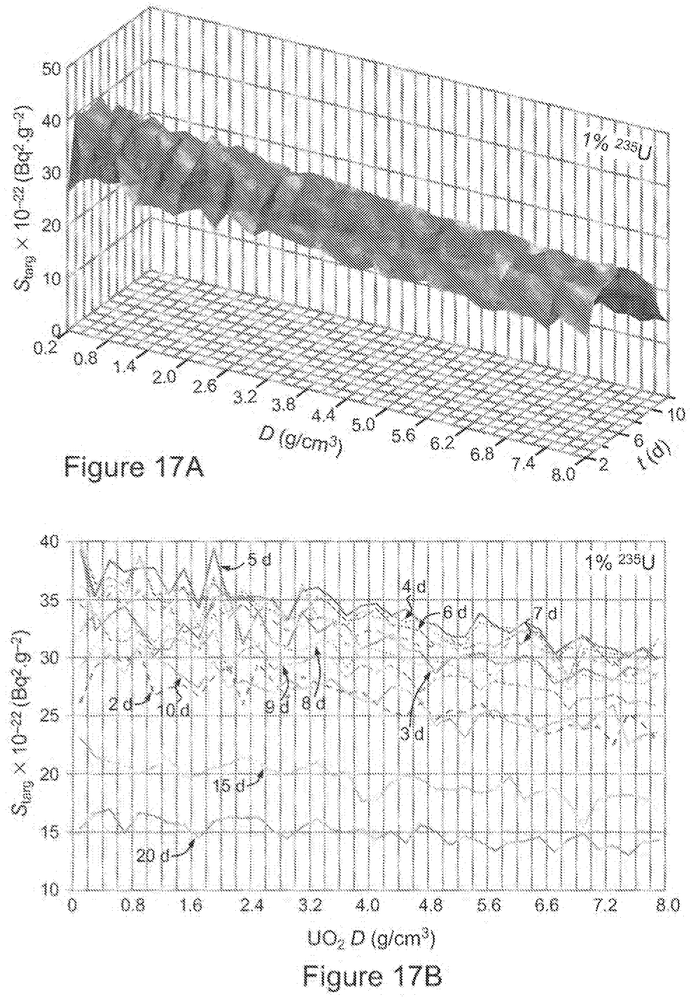

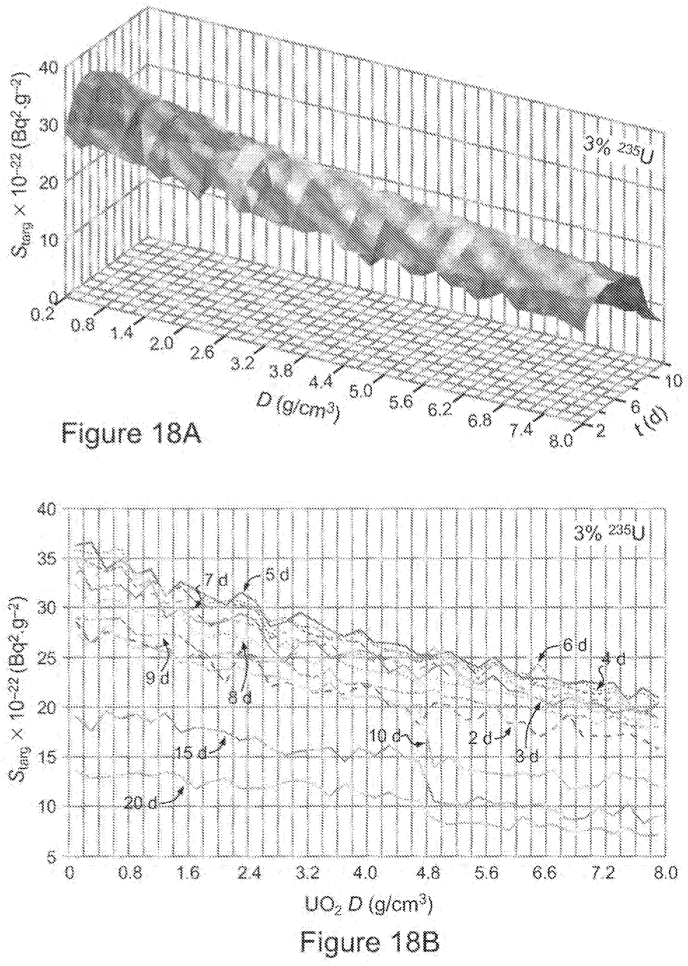

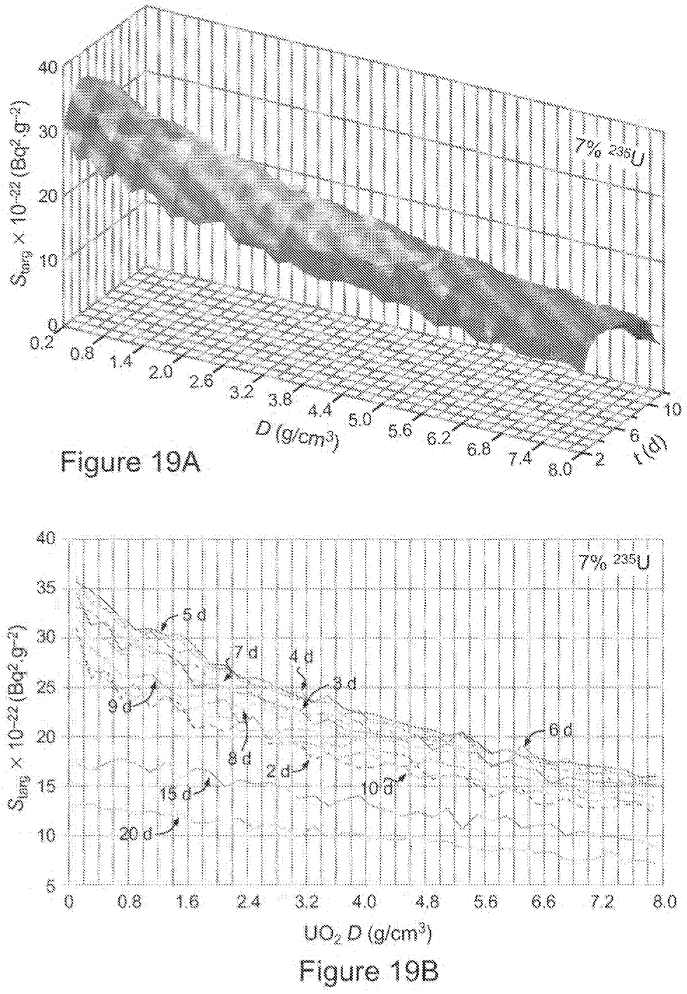

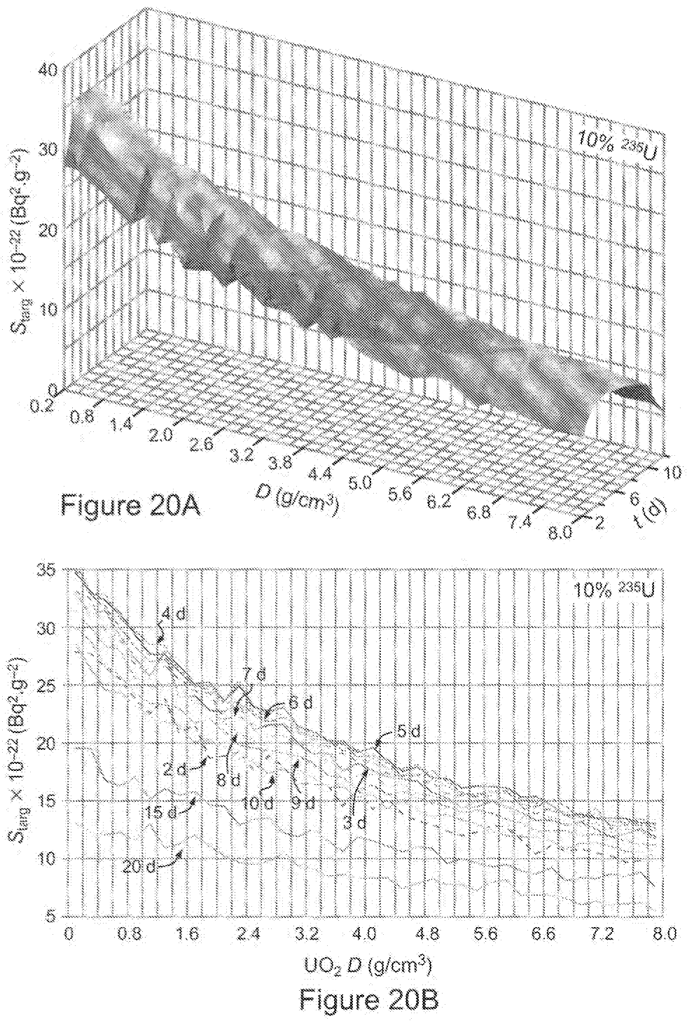

FIGS. 17A to 20B, however, are corresponding graphs of sustainability index S_{targ}, plotted as sustainability index (S_{targ}) in Bq²·g⁻² versus UO₂ density (D) in g/cm³ and versus irradiation time (t) in days. FIGS. 17A and 17B are 3D and 2D plots respectively for 1% enrichment, FIGS. 18A and 18B are 3D and 2D plots respectively for 3% enrichment, FIGS. 19A and 19B are 3D and 2D plots respectively for 7% enrichment, and FIGS. 20A and 20B are 3D and 2D plots respectively for 10% enrichment.

From FIGS. 17A to 20B it may be seen that the optimal ranges of the target sustainability index lie in the ranges of 4 to 7 days irradiation time. The highest sustainability index (39.99×10⁻²² Bq²·g⁻²) was obtained at 6 days irradiation with a ²³⁵U enrichment of 1% and a UO₂ density of 0.2 g/cm³ (cf. FIG. 17B), yielding a total output of 407 GBq—which is relatively low and suggests a limitation to the use the sustainability index alone. In contrast, the highest total output was 70818 GBq at 15 days irradiation with a ²³⁵U enrichment of 10% and a UO₂ density of 7.8 g/cm³ (cf. FIG. 20B), with a sustainability index of 88.16×10⁻²² Bq²·g².

In a commercial context, a program for the manufacture of ⁹⁹Mo will commonly be expressed in terms of the amount of ⁹⁹Mo to be produced in a specific period. For example, the ⁹⁹Mo manufacturing plant of the Australian Nuclear Science and Technology Organisation was designed to produce 3000 curie (=111 TBq) per week. Hence, in practical applications it may be important to determine the most sustainable process (viz. with the highest sustainable index) that produces a specified total activity (e.g. A_{T}=111 TBq) in a specified target irradiation time (e.g. 4≤t≤7 days: cf. the simulations discussed above).

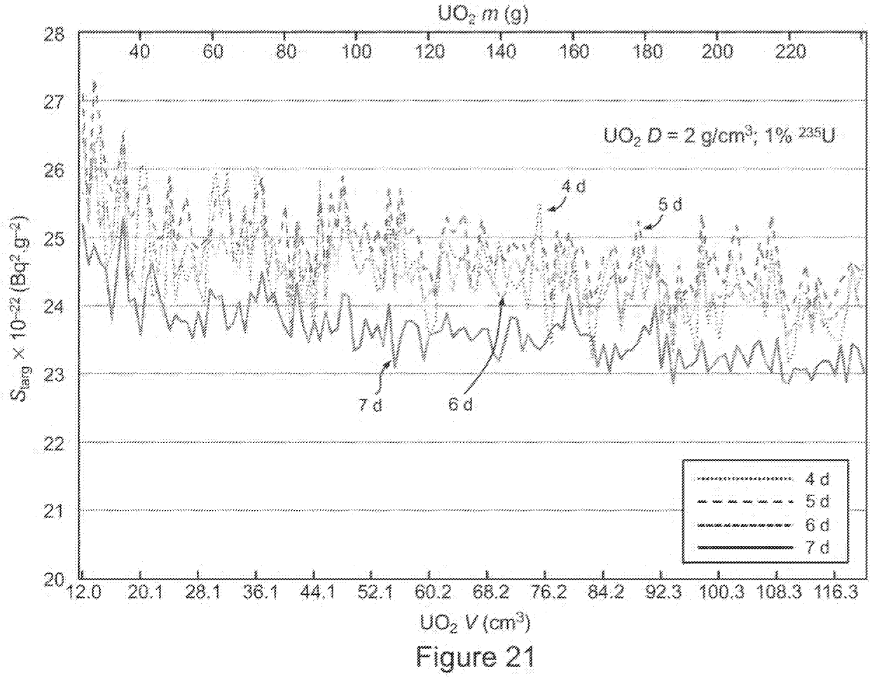

FIG. 21 is a plot of sustainability index (S_{targ}) in Bq²·g⁻² versus UO₂ target volume (V) in cm³ (with initial UO₂ target mass (m) in g plotted along the upper horizontal axis), for a ²³⁵U target enrichment of 1% and 4, 5, 6 and 7 day irradiations. The UO₂ target density was modelled as 2 g/cm³.

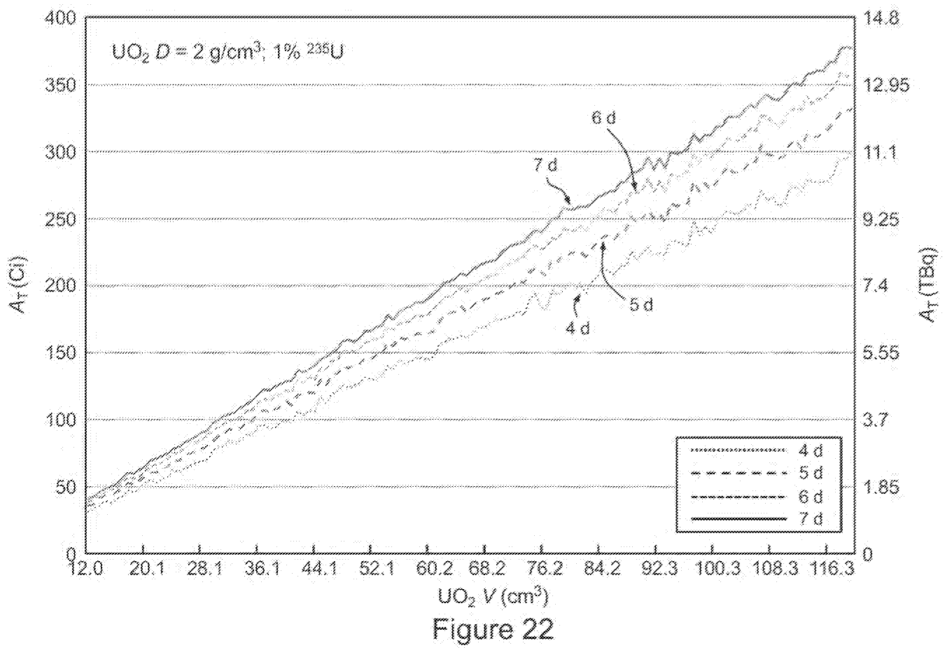

FIG. 22 is a plot, for the same simulation as that of FIG. 21, of total ⁹⁹Mo output (A_{T}) in Ci (left vertical axis) and TBq (right vertical axis) versus initial UO₂ target volume (V) in cm³.

From FIG. 21, it can been seen that the sustainability index per target volume is relatively flat over the range of the plot. (The scatter in the data is merely the result of the Monte-Carlo nature of the MCNP6 modelling.) FIG. 22 shows that ⁹⁹Mo output increases (for a fixed target density and while maintaining a relatively flat sustainability: cf. FIG. 21) essentially linearly with increasing target volume.

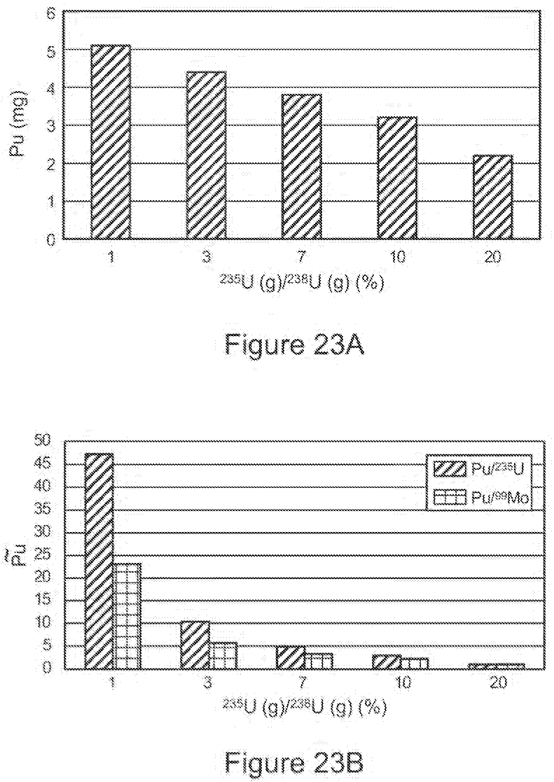

FIG. 23A is a plot of modelled plutonium production Pu (mg) for various initial target matrix ²³⁵U/²³⁵U enrichments, a 6 day irradiation period, a target volume of 12 cm³ and a target density of 2.6 g/cm³, for a target in the configuration of FIG. 2. The initial mass of ²³⁵U was 0.22 g.

It will be noted that plutonium production decreases essentially monotonically with increasing ²³⁵U enrichment.

FIG. 23B is a plot of modelled normalized plutonium production \tilde{P}u for various initial target matrix ²³⁵U/²³⁸U enrichments, shown relative to both ²³⁵U enrichment and elemental ⁹⁹Mo production—normalized to the plutonium production with 20% ²³⁵U enrichment. A 6 day irradiation was again employed, as was a target volume of 12 cm³, a target density of 2.6 g/cm³, and an initial mass of ²³⁵U of 0.22 g. The configuration was again that of FIG. 2.

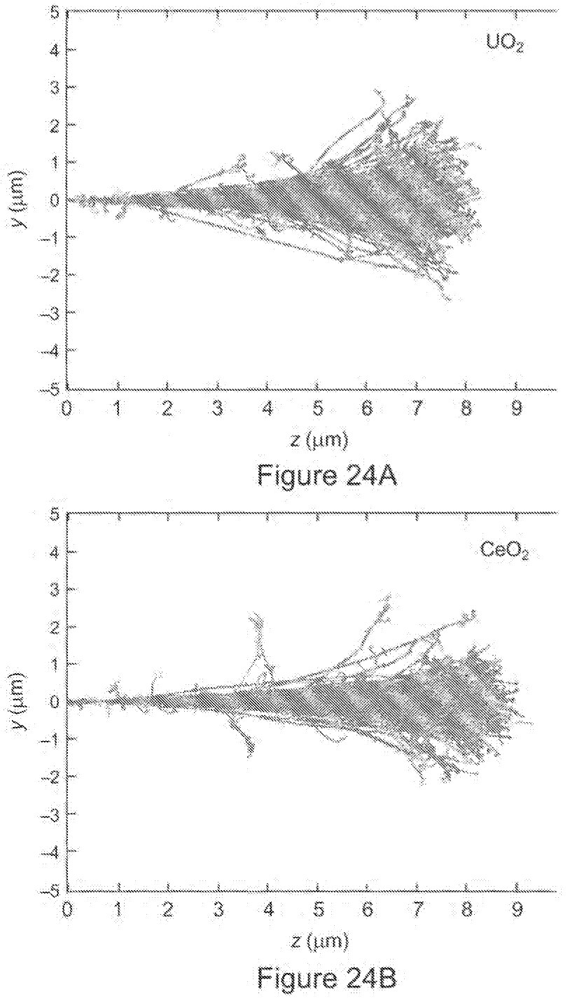

FIG. 24A is a plot of a simulation of the stopping and range of 200 ⁹⁹Mo ions (with full cascades) of 90 MeV, travelling in the +z direction and hitting a UO₂ substrate at (x, y, z)=(0, 0, 0), plotted as y-axis position y (μm) against substrate depth z (μm) of the Mo ions. The plots shows the trajectories of both the original ⁹⁹Mo ions and knock-on ions (the latter being in a slightly lighter shade of grey). The simulation was generated with the SRIM (‘Stopping and Range of Ions in Matter’) computer program package.

The simulation employed a UO₂ density of 10.97 g/cm³, and SRIM's standard stopping energies. The average longitudinal range (that is, in the +z direction) of the Mo ions was found to be 7.16 μm with a straggle of 6489 A. The average radial range of the Mo ions was 1.20 μm with a straggle of 5983 A.

FIG. 24B is a comparable plot of a simulation of the stopping and range of 200 ⁹⁹Mo ions (with full cascades) of 90 MeV, travelling in the +z direction and hitting a CeO₂ substrate at (x, y, z)=(0, 0, 0), also modelled with SRIM. The simulation employed a CeO₂ density of 7.22 g/cm³, and SRIM's standard stopping energies. The average longitudinal range (that is, in the +z direction) of the Mo ions was found to be 8.19 μm with a straggle of 4637 Å. The average radial range of the Mo ions was 0.924 μm with a straggle of 4966 Å. The plot shows the trajectories of both the original ⁹⁹Mo ions and knock-on ions (the latter being in a slightly lighter shade of grey). There are more knock-on ions in this plot than in that of FIG. 24A because the cerium is more easily displaced than the uranium.

These plots simulate the travel of the ⁹⁹Mo within, and hence likelihood of ejection from, UO₂ and CeO₂, respectively. It may reasonably be expected that the range of the ⁹⁹Mo in a mixture of UO₂ and CeO₂ would be essentially a linear combination of the individual ranges. For example, a target with a UO₂ to CeO₂ ratio of 50:50 may be expected to have a ⁹⁹Mo range that is approximately the average of the two shown in these plots.

It is evident from these simulations that Mo ions travel further and deviate less in CeO₂ than in UO₂, as might be expected in view of the lower density of CeO₂. Channeling and other effects are expected to be essentially the same, owing to the similar crystal structures of UO₂ and CeO₂. Thus, from this perspective there should be no disadvantage to the use of CeO₂ in conjunction with UO₂, and the greater range of the Mo ions in CeO₂ will—all things being equal—increase the proportion of ⁹⁹Mo that will be ejected.

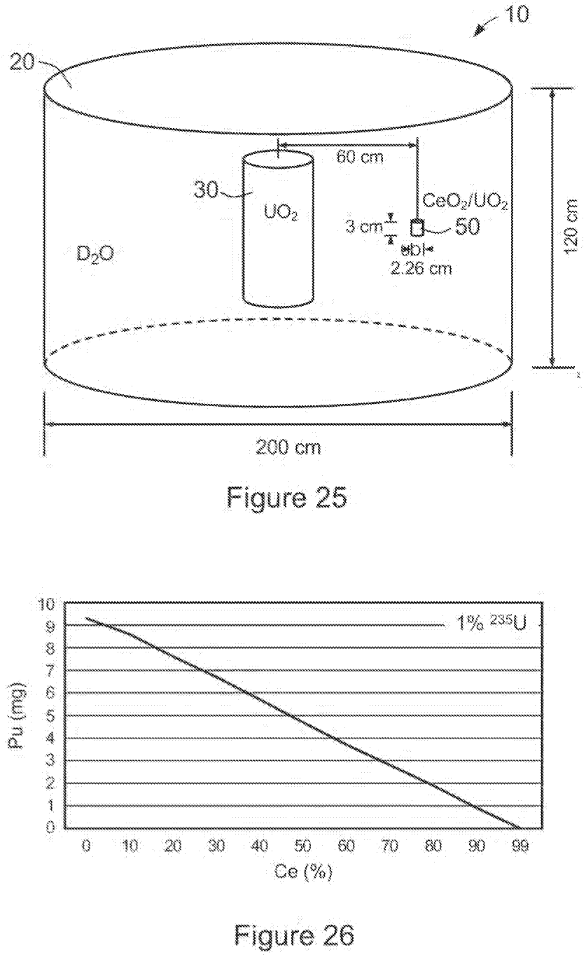

FIG. 25 is a schematic view of reactor model 10 and UO₂ core 30 of FIG. 1 with a (modelled) reusable target 50 (not shown to scale) according to an embodiment of the present invention. Reusable target 50 is, in most respects, comparable to target 40 of FIG. 2 being cylindrical, with a height of 3 cm, a radius of 1.13 cm and hence a volume of 12.03 cm³. Reusable target 50 was modelled as being located with its central axis 60 cm from and parallel to the central axis of UO₂ core 30, to simulate a potential position of a target rig in a reactor.

However, reusable target 50 comprises a porous matrix of particles that comprise a mixture of UO₂ and CeO₂ (of natural cerium) in a U:Ce molar ratio of 50%. The particles have a size (viz. mean diameter) of 6 μm. In this example, the molar ratio of ²³⁵U to Ce and ²³⁸U is approximately 1%, so the target contains ²³⁵U, ²³⁸U and Ce in the (molar) proportions of approximately 1:49:50. This corresponds to a UO₂ feedstock with an ²³⁵U enrichment of approximately 2%.

Target 50 is thus comparable in performance to a UO₂ target of like characteristics (but omitting cerium) of 1% ²³⁵U enrichment, such that ²³⁵U and ²³⁸U are present in the molar ratio of approximately 1:99. However, owing to what is, in effect, the substitution of 49/99=49.5% of the ²³⁸UO₂ with CeO₂, the density of target 50 is approximately 17% lower than the density the comparable UO₂ only target—with the benefit of facilitating ⁹⁹Mo ejection, as discussed above.

FIG. 26 is a plot of modelled plutonium production Pu (mg) for exemplary UO₂ targets that include CeO₂, as a function of (natural) Ce content (%) (with 1% ²³⁵U, and the balance comprising ²³⁵U—hence with effectively varying ²³⁵U enrichment), for a 6 day irradiation, a target volume of 32.89 cm³ (hence larger than that of FIG. 24) and a target density of 2 g/cm³. The initial mass of ²³⁵U was 0.6 g. The percentages are mass percentages. The modelled target includes CeO₂, and the configuration is that of FIG. 24, so also comparable to that of FIG. 2.

It is evident that plutonium production can be substantially reduced by, in effect, substituting CeO₂ for 2³⁸UO₂. It will be noted that—with 1% ²³⁵U and 99% Ce and hence no ²³⁸U—plutonium production is effectively eliminated.

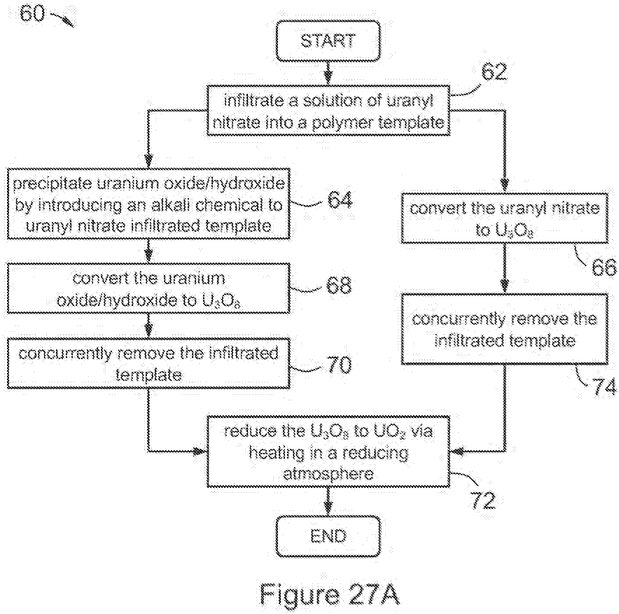

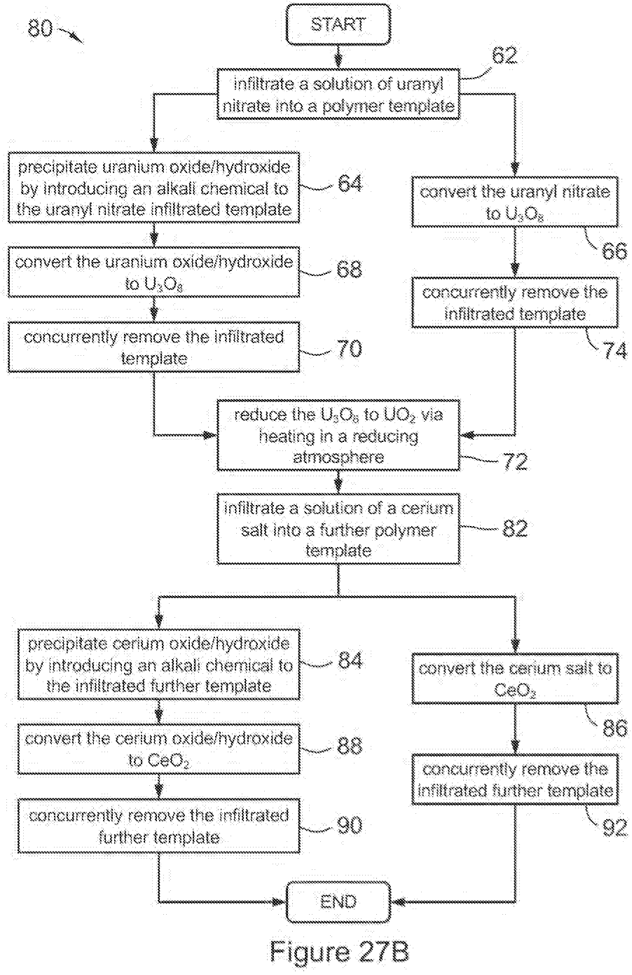

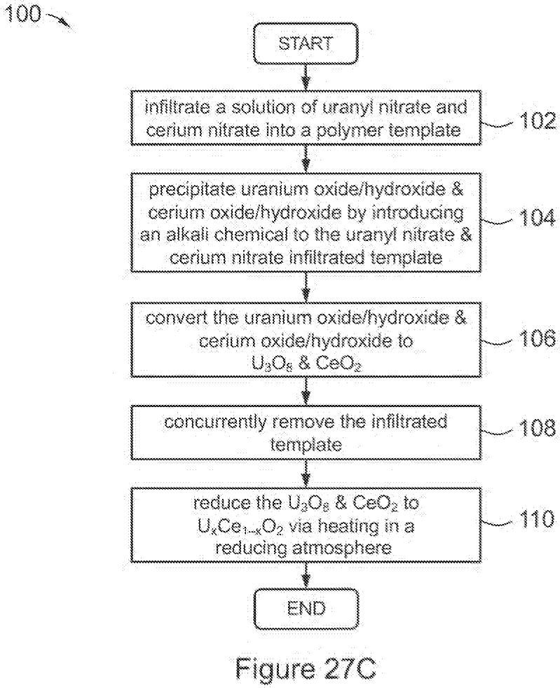

FIGS. 27A and 27B are, respectively, a flow diagram of a method 60 of manufacturing particles (e.g. beads) of UO₂ for the porous matrix of a target for use in the manufacture of ⁹⁹Mo, and a flow diagram of a method 80 of manufacturing particles of UO₂ and particles (e.g. beads) of CeO₂ for the porous matrix of such a target, both according to embodiments of the present invention.

Referring to FIG. 27A, at step 62 of method 60, a solution of uranyl nitrate is infiltrated into a polymer template (such as a template of PAN, such as in the form of PAN beads). The method 60 can then continue either at step 64 or step 66. If continuing at step 64, a gaseous base or other alkali chemical (such as gaseous ammonia) is introduced to the uranyl nitrate infiltrated polymer template, causing precipitation of uranium oxide/hydroxide.

By heating the infiltrated polymer template, the uranium oxide/hydroxide is converted into U₃O₈ (cf. step 68) and, concurrently, the polymer template is removed (cf. at step 70). The method then continues at step 72, where the U₃O₈ is reduced to UO₂ via heating (such as at a maximum temperature of 1000° C.) in a reducing atmosphere (such as 3.5% hydrogen in nitrogen gas).

It will be understood that effecting steps 68 and 70 concurrently (and other pairs of steps described and claimed herein as performed concurrently) does not imply that both steps will commence simultaneously (once heating commences) or reach completion simultaneously.

If, after step 62, the method continues at step 66, then by heating the infiltrated polymer template, the uranyl nitrate is converted into U₃O₈ (cf. step 66) and, concurrently, the polymer template is removed (at step 74).

The uranyl nitrate may be converted into U₃O₈ (see step 66) by removing the nitrate by, for example, direct denitration. For example, this can be done by heating the sample (e.g. to >300° C., thereby also effecting the concurrent template removal of step 74) in a rotary kiln or a fluidized bed reactor. The rotary kiln is harsher, and may crush the beads owing to their fragility, so it is envisaged that a fluidized bed reactor is likely to be more advantageous in that regard.

The method then continues at step 72.

Steps 70 and/or 74 may comprise heating the infiltrated polymer template to a maximum temperature of 400° C.

Referring to FIG. 27B, steps 64 to 72 for the manufacture of particles of UO₂ proceed as shown in FIG. 27A, and like reference numerals have been used to identify like steps. Subsequently, or concurrently, at step 82 a solution of a cerium salt is infiltrated into a further polymer template (such as a template of PAN, such as in the form of PAN beads). The method 80 can then continue either at step 84 or step 86. If continuing at step 84, a gaseous base or other alkali chemical (such as gaseous ammonia) is introduced to the infiltrated further polymer template, causing precipitation of cerium oxide/hydroxide. By heating the infiltrated further polymer template, the cerium oxide/hydroxide is converted into CeO₂ (cf. step 88) and, concurrently, the further polymer template is removed (cf. step 90).

If, after step 82, the method instead continues at step 86, by heating the infiltrated further polymer template (such as in a fluidized bed reactor), the cerium salt is converted into CeO₂ (cf. step 86) and, concurrently, the further polymer template is removed (cf. step 92).

Thus, if the particles of UO₂ and the particles of CeO₂ are formed sequentially, they can then be mixed in readiness for forming the matrix. In addition, the method can include controlling the ratio of cerium and uranium by controlling the amount or amounts of infiltration of the cerium salt (at step 82) and uranyl nitrate (at step 62).

FIG. 27C is a flow diagram of a method 100 of manufacturing particles (e.g. beads) of UO₂ and CeO₂ for a porous matrix of a target for use in manufacture of ⁹⁹Mo, according to embodiments of the present invention.

Referring to FIG. 27C, at step 102, a solution containing uranyl nitrate and cerium nitrate (in known molar ratios) is infiltrated into a polymer template (such as a template of PAN, such as in the form of PAN beads).

At step 104, a gaseous base or other alkali chemical (such as gaseous ammonia) is introduced to the uranium and cerium nitrate infiltrated polymer template, causing co-precipitation of the uranium oxide/hydroxide and cerium oxide/hydroxide. By heating the infiltrated polymer template, the uranium oxide/hydroxide and cerium oxide/hydroxide are converted to respectively U₃O₈ and CeO₂ (cf. step 106) and, concurrently, the polymer template is removed (cf. step 108).

At step 110, the U₃O₈ and CeO₂ is reduced to a UO₂/CeO₂ system (UₓCe₁₋ₓO₂, where x is the initial molar mixing ratio of uranium and cerium) in a reducing atmosphere (such as 3.5% hydrogen in nitrogen gas).

The particles of UO₂ and CeO₂ are formed non-sequentially (concurrently), and method 100 can include controlling the amount or amounts of infiltration of the uranyl nitrate and cerium nitrate (step 102) to achieve a desired molar ratio.

Subsequently, the size of the particles will depend on (and be controlled by) for how long and/or at how high a temperature sintering is performed when forming the porous matrix.

Manufacture of Porous UO₂ and UₓCe₁₋ₓO₂ Targets Using Nanocasting

The synthesis of porous CeO₂ (acting as a UO₂ simulant), UO₂ and UₓCe₁₋ₓO₂ were investigated using nanocasting, with the object of making a porous UO₂ system for ⁹⁹Mo production with a particular focus on materials with a lower density and higher volume compared to conventional smaller volume, high density ⁹⁹Mo production targets.

### Methods and Materials

In the following examples, simultaneous thermal gravimetric and differential scanning calorimetry analysis (TG-DSC) data were recorded using a Netzsch STA449F3 (trade mark) heating at a rate of 5° C. min⁻¹ under a flow of either Ar or 20% O₂ in N₂ at 30 cm³·min⁻¹. Gas adsorption studies were carried out using a Quantachrome (trade mark) Autosorb MP instrument and high purity nitrogen gas (99.999%). Surface areas were determined using Brunauer-Emmett-Teller (BET) calculations.

A Zeiss Ultra Plus (trade mark) scanning electron microscope (SEM, Carl Zeiss NTS GmbH, Oberkochen, Germany) operating at 15 kV equipped with an Oxford Instruments X-Max (trade mark) 80 mm² SDD X-ray microanalysis system was used to check the crystal morphology and electron dispersive spectroscopy (EDS) calibrated with a Cu standard for the determination of key elements.

Synthesis of UₓCe₁₋ₓO₂ Beads

An aqueous solution was prepared by dissolving known amounts of UO₂(NO₃)₂·6H₂O and Ce(NO₃)₃·6H₂O in H₂O to achieve a desired molar ratios (100% uranium, 100% cerium, 5% uranium in cerium). This solution was then used for infiltration into polyacrylonitrile (PAN) beads. The PAN beads were synthesized using the method described by J. Veliscek-Carolan et al. (2015). The infiltration was achieved by heating the PAN-U/Ce solution in an oven at 60° C. overnight (Ibid).

Upon infiltration, the beads were removed from the U/Ce solution and vacuum dried at room temperature for 60 minutes. After drying, the beads were placed in an evaporating dish alongside a separate dish containing a solution of a base (e.g. for 100% cerium and 5% uranium in cerium: a 20% ammonia solution). The evaporating dish was covered and left overnight. The beads were collected the next day and washed with H₂O three times over three hours and left to air dry.

Air Calcination of UₓCe₁₋ₓO₂ Beads

The beads were heated in air at a rate of 1° C./min to 400 or 800° C. and held at this temperature for 5 hours before being cooled to room temperature.

Pyrolysis of UₓCe₁₋ₓO₂ Beads

Uncalcined beads were first heated in air at a rate of 1° C./min to 230° C. and held at this temperature for 3 hours before being cooled to room temperature. The beads were then heated under argon at a rate of 1° C./min to 800° C. or 1200° C. and held at this temperature for 3 hours before cooling to room temperature.

### Results and Discussion

### Material Synthesis

The synthesis of the uranium-cerium containing beads was achieved in a two-stage process. The first stage involves infiltrating the PAN beads with the desired molar ratio of U/Ce in a concentrated aqueous solution containing known amounts of UO₂(NO₃)₂·6H₂O and Ce(NO₃)₃. The need for an aqueous solution is evident by the incompatibility of PAN with concentrated amounts of nitrate i.e., a melt reaction.

Upon infiltration, to convert the NO₃ species to their oxide counterparts, the U/Ce is precipitated as UₓCe₁₋ₓO₂ via vapour diffusion of a base such as NH₃ using a covered evaporating dish. Removal of the nitrate species was achieved by washing the precipitated UₓCe₁₋ₓO₂@PAN with water. The molar ratios explored so far are UO₂, CeO₂ and U_{0.05}Ce_{0.95}O₂, with precipitation using gaseous NH₃ used for both the CeO₂ and U_{0.05}Ce_{0.95}O₂ samples.

Upon precipitation, the PAN was removed by heating the samples under a controlled atmosphere. Two atmospheres have been explored so far. The use of an air atmosphere can be used to completely remove the PAN, with the resulting porous material existing entirely as UₓCe₁₋ₓO₂. The alternative option is to use an Ar atmosphere to pyrolyze the material, resulting in decomposition of the PAN without completely removing the carbon. The purpose of leaving the carbon within the structure is to ideally make the beads more robust and mechanically stable, so that they are suitable for use as a reusable ⁹⁹Mo production system. Explored below is the characterization of the materials under both atmospheres.

### Thermal Characterisation

TG-DSC was performed on the CeO₂@PAN to determine the temperature at which the PAN can be removed from the structure, and to ensure the remaining CeO₂ remained thermally stable past this point. As the equipment is located in a non-active area, only characterization of the inactive CeO₂ material has been performed thus far.

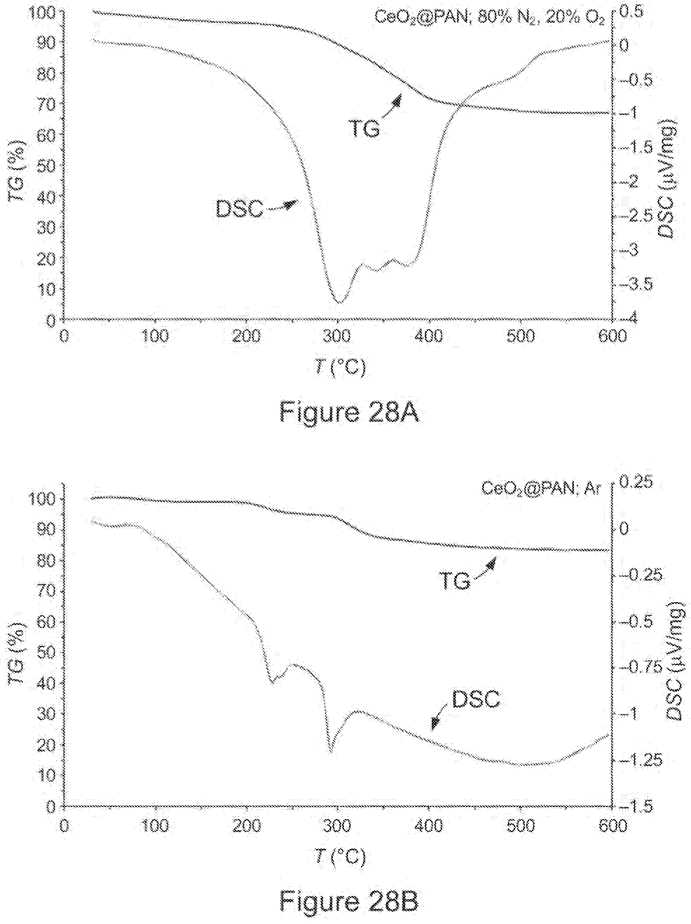

FIG. 28A is an TG-DSC trace obtained while heating CeO₂@PAN to 600° C. under an atmosphere of 20% O₂ in N₂ (compressed ‘air’). This revealed that the material was stable until around 250° C. A mass loss of 30% was then observed between 250° C. and 400° C. which was coupled with a series of exothermic events in the DSC trace. The exothermic events are characteristic of bond breakage, which when coupled to the mass loss correlate to the decomposition and loss of the PAN from the material.

The stable mass and return of the DSC trace back to zero after this loss of PAN suggests a completed reaction, and thus the amount of PAN within the material can be totaled as ˜30% of the total mass. Additionally, this confirms that 400° C. is the minimum target temperature to remove the PAN from the porous beads, leaving behind just CeO₂.

FIG. 28B is an TG-DSC trace obtained while heating CeO₂@PAN to 600° C. under an Ar atmosphere. This was performed to examine the behaviour of the material during pyrolysis. A small mass loss prior to 200° C. can be attributed to the loss of water, with the otherwise stable trace comparable to that of the sample heated under air (cf. FIG. 28A). Referring to FIG. 28B, two mass loss steps were then observed at 220° C. and 295° C., which were coupled to sharp exothermic events in the DSC trace correlating to bond breakage and a small material loss. Under pyrolytic conditions, the breakdown of PAN should involve the loss of nitrogen and hydrogen, with the carbon remaining within the material. The hydrogen and nitrogen make up ˜32% of PAN, and therefore a mass loss of 32% of the total amount of PAN within the material is envisaged. If it is assumed that the PAN makes up ˜30% of the total mass as determined by TG-DSC under air (cf. FIG. 28A), this should therefore result in an approximate mass loss of 10%—which closely matches the observed result. The TG trace remains steady after this point, confirming complete reaction of the PAN and suggestive of an Ar calcine temperature of 400° C.

### Structural Discussion (SEM)

SEM-EDS was the primary method chosen to examine the UₓCe₁₋ₓO₂ beads after calcination under both an air and Ar atmosphere, focusing on determining (a) whether the porous structure remains intact upon removal of the PAN, and (b) the resulting pore widths and hierarchical porosity.

SEM of CeO₂ after Air Calcination

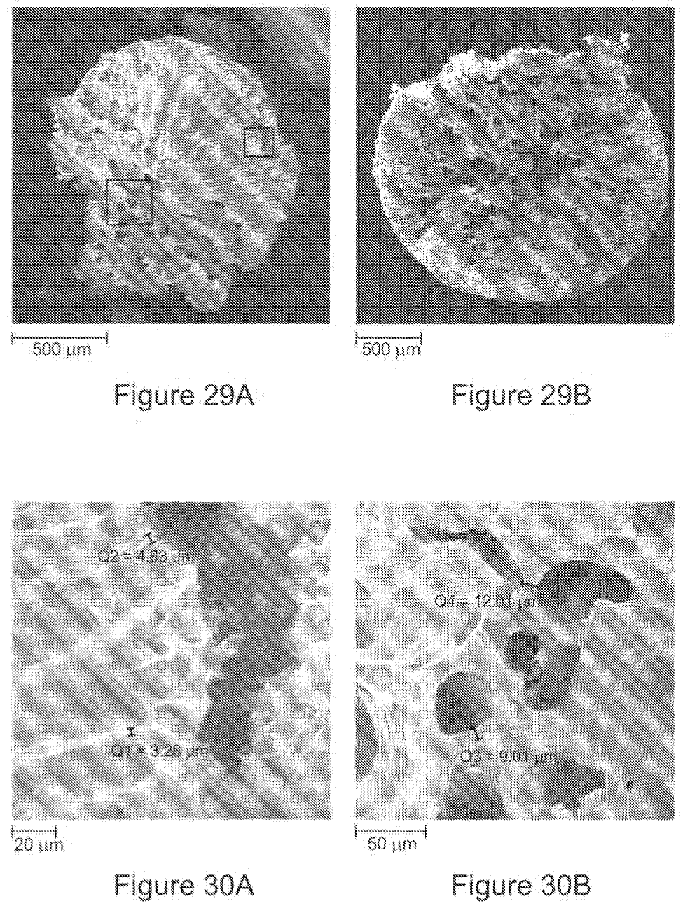

FIGS. 29A and 29B are SEM images of fractured air-calcined CeO₂ beads after calcination at 400° C. FIGS. 30A and 30B are SEM images of two pore locations within the air-calcined CeO₂ bead of FIG. 29A, exhibiting pore wall thicknesses of from ˜4 μm to ˜12 μm. The fields of view of FIGS. 30A and 30B correspond approximately to the boxes superimposed on FIG. 29A: FIG. 30A corresponds to the boxed area towards the upper right of the bead of FIG. 30A, while FIG. 30B corresponds to the boxed area near the centre of the bead (not of the field of view) of FIG. 30A.

These images reveal an intact bead exhibiting clear hierarchical porosity throughout. The pore wall thicknesses were examined, revealing that the walls were progressively thicker closer to the centre of the bead. The pores near the outer edges of the beads had wall thicknesses of 3.5-4.5 μm (see FIG. 30A, in which wall Q1 has a thickness of 3.28 μm and wall Q2 has a thickness of 4.63 μm); the pores closer to the centre of the porous structure had wall thicknesses of 9-12 μm (see FIG. 30B, in which wall Q3 has a thickness of 9.01 μm and wall Q4 has a thickness of 12.01 μm). With a desired wall thickness around 5 μm, these results suggest that these porous CeO₂ beads have the desired properties.

SEM of UO₂ after Air Calcination

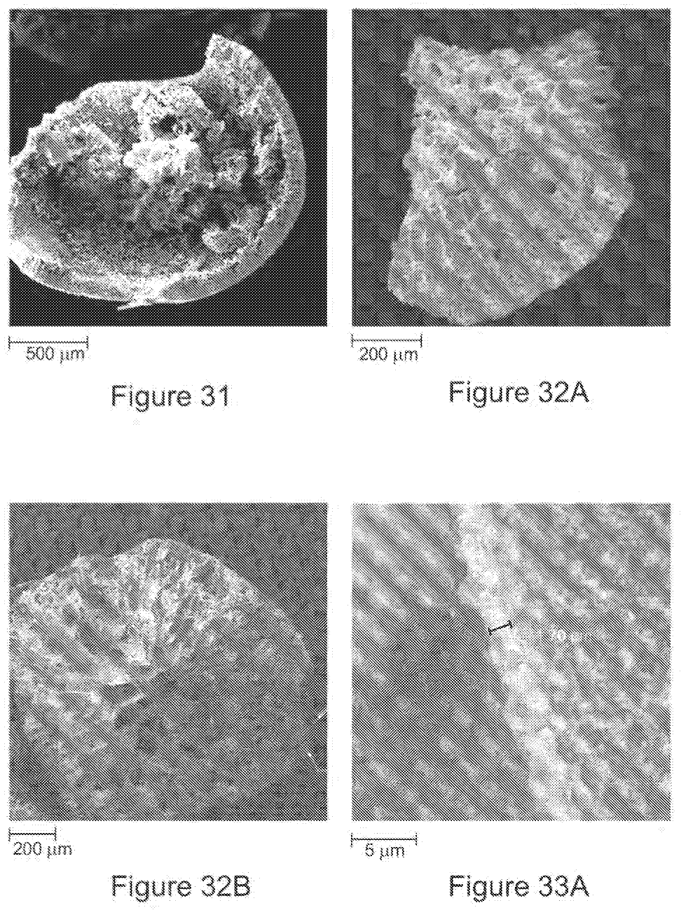

The same calcination procedure was applied to porous UO₂ beads, but the SEM results confirmed that the internal structure of the bead was not intact after PAN removal. FIG. 31 is an SEM image of such a fractured air-calcined UO₂ bead. Owing to the thick, seemingly fused edge of the intact outer shell, it is supposed (but without being bound by theory) that—during the gaseous NH₃ infiltration—the UO₂ was precipitating out almost immediately, resulting in clogged pores that prevented further infiltration of the NH₃, such that—during PAN removal—the inner surfaces of the bead not being in their oxide form resulted in PAN decomposition and loss of the heirarchichal porosity.

Consequently, weaker gasesous bases are proposed, to allow the base to infiltrate the bead further before precipitation of the UO₂.

SEM of CeO₂ after Ar Calcination

FIGS. 32A and 32B are SEM images of fractured, pyrolyzed CeO₂ beads after calcination under Ar at 600° C. FIGS. 32A and 32B reveal that structure and hierarchical porosity were maintained.

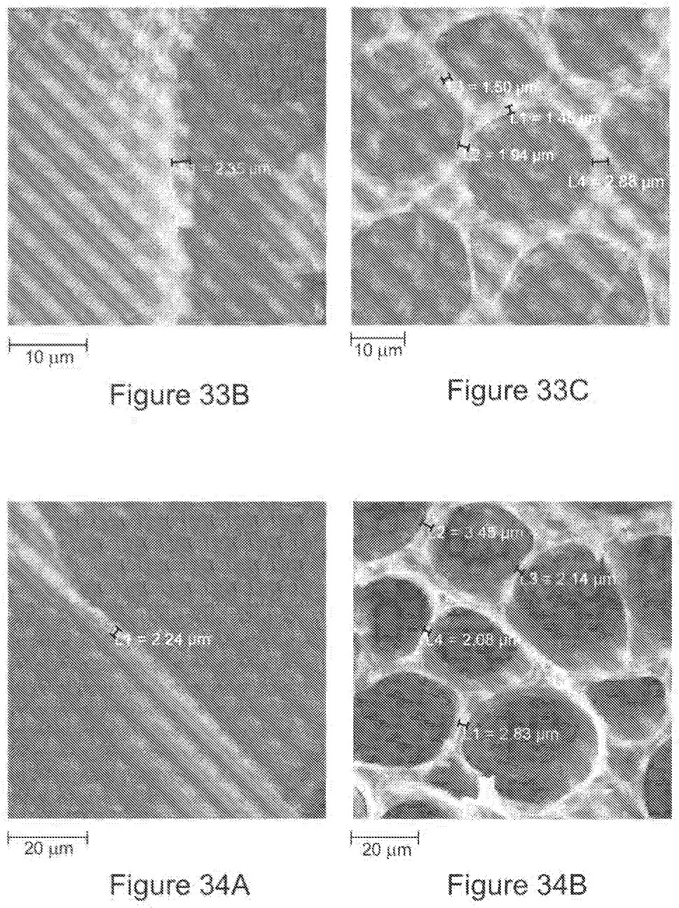

FIGS. 33A, 33B and 33C are SEM images of pore locations within a 600° C. Ar-calcined CeO₂ bead (found in the same material as were the beads of FIGS. 32A and 32B). Examination of pore wall thickness revealed much thinner walls compared to the same material under an air calcine, with pore walls of from ˜1.5 μm to ˜2.9 μm being observed.

FIGS. 34A and 34B are SEM images of pore locations within 800° C. Ar-calcined CeO₂ beads. To produce thicker pore walls, two other heating protocols were applied, with the material heated under Ar to either 800° C. or 1200° C. The CeO₂ sample calcined at 800° C. showed a slight increase in the width of the pore walls, with the observable thickness now in a range of ˜2.2 μm to 3.5 μm, as is apparent from FIGS. 34A and 34B.

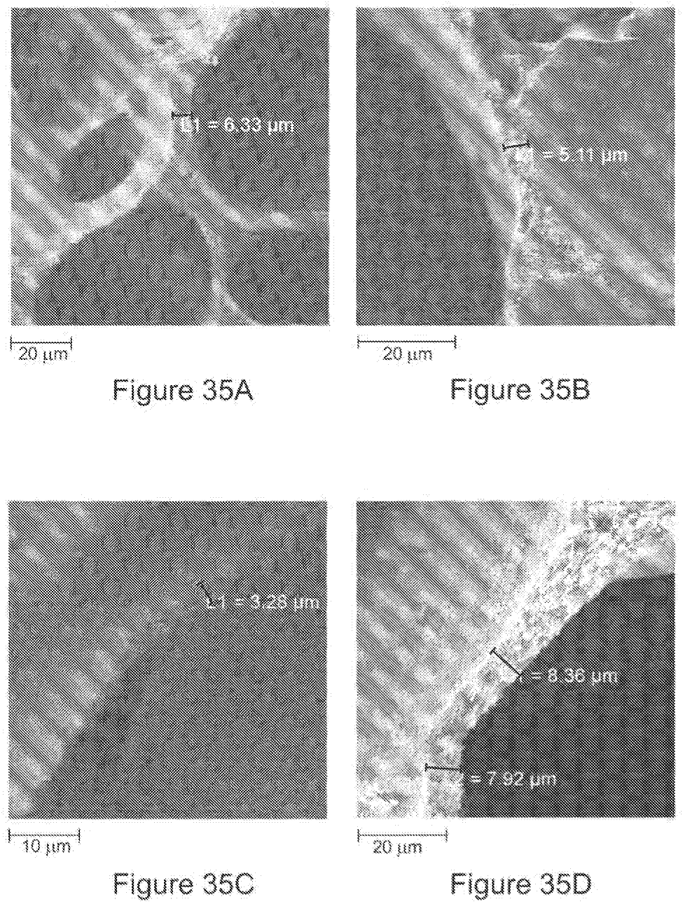

FIGS. 35A, 35B, 35C and 35D are SEM images of pore locations within 1200° C. Ar-calcined CeO₂ beads. Increasing the calcination temperature to 1200° C. appears to have had a significant effect on the structure, with pore wall thicknesses of ˜3.3 μm to ˜8.4 μm.

The achievability of these pore wall thicknesses achievable established that the desired properties for a target could also be achieved under pyrolytic conditions.

SEM-EDS of U_{0.05}Ce_{0.95}O₂ after Ar Calcination

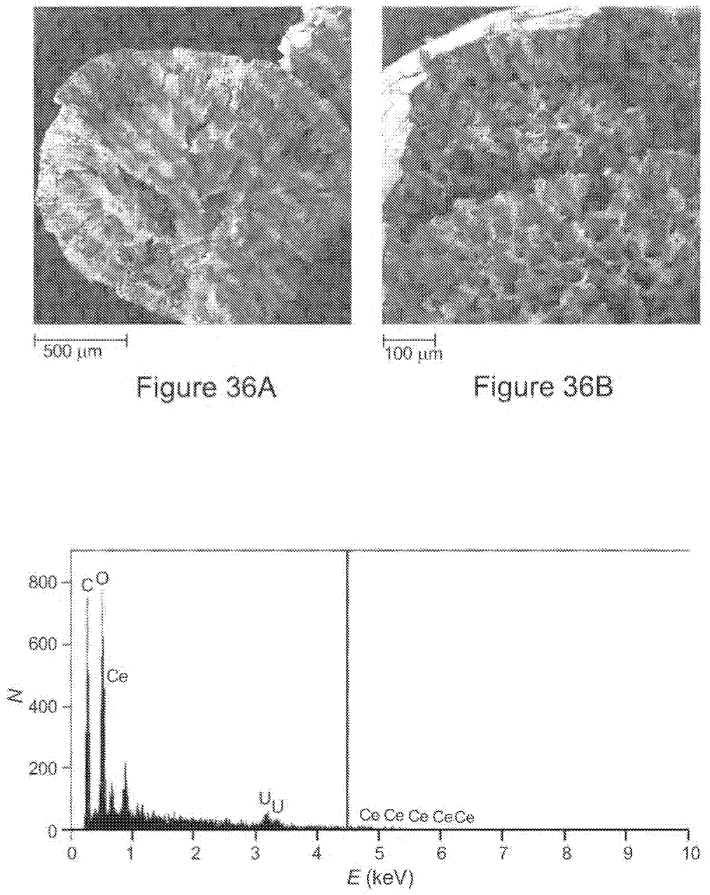

Synthesis and subsequent characterization of a 5% uranium in cerium (U_{0.05}Ce_{0.95}O₂) bead was also performed using the gaseous NH₃ precipitation method, and subsequently characterized with SEM-EDS. FIGS. 36A and 36B are SEM images of fractured Ar-calcined U_{0.05}Ce_{0.95}O₂ beads after calcination at 800° C. These images suggest that the beads had remained intact, with hierarchical porosity extending throughout.

FIG. 37 is an EDS spectrum of a point within the material of the beads of FIGS. 36A and 36B, plotted as counts (N) versus energy (E). The spectrum shows that both U and Ce have been incorporated into the structure, with uranium making up the minor component that correlates to the 95:5 molar ratio used.

Mechanical Stability of CeO₂ Beads after Air and Ar Calcination

These observations suggest that the air calcined material is much more delicate than the same material after Ar calcination. The air calcined beads appear unable to be handled with tweezers without extreme care, whilst the Ar beads are much more robust, increasing in apparent structural integrity as the calcination temperature is increased.

### Porosimetry

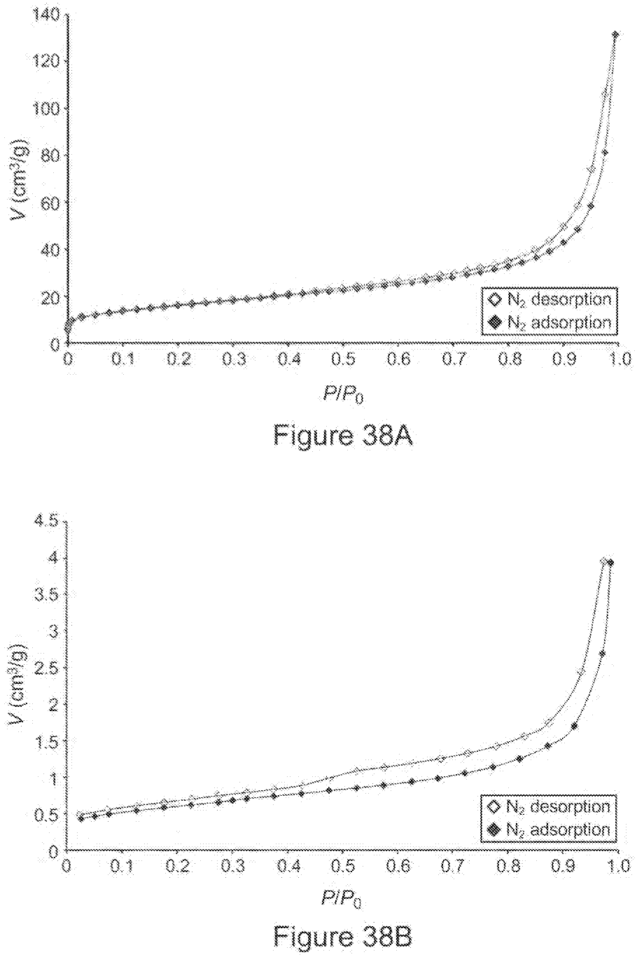

Porosimetry was performed on two samples: CeO₂ beads after air calcination at 400° C. and CeO₂ beads after Ar calcination at 1200° C. Thus, FIGS. 38A and 38B are plots of N₂ sorption isotherms at 77 K of CeO₂ heated at, respectively, 400° C. under air and 1200° C. under Ar. In these figures, volume (V) of gas absorbed per gram at STP is plotted against partial pressure (P/P₀).

The N₂ isotherms, measured at 77 K, reveal that both samples remained porous upon calcination and removal of the PAN. The air calcined CeO₂ beads were calculated to have a BET surface area of 57.823 m²/g, which dropped to 11.212 m²/g in the Ar calcined beads. One possible reason for this decrease is the carbon remaining in the Ar calcined material, which would reduce the accessible pore space compared to the purely CeO₂ samples made under the air calcination. However, even with the lower observed surface area, the beads remain porous so constitute a reusable platform for ⁹⁹Mo production.

It is to be understood that, if any prior art is referred to herein, such reference does not constitute an admission that the prior art forms a part of the common general knowledge in the art in any country.

In the claims which follow and in the preceding description of the invention, except where the context requires otherwise owing to express language or necessary implication, the word “comprise” or variations such as “comprises” or “comprising” is used in an inclusive sense, i.e. to specify the presence of the stated features but not to preclude the presence or addition of further features in various embodiments of the invention.

### REFERENCES

Aldawahrah, S., et al., Calculation of fuel burnup and radionuclide inventory for the HEU and potential LEU fuels in the IRT research reactor, Results in Physics, 11 (2018) 564-569.
Bourasseau, E., et al., Experimental and simulation study of grain boundaries in UO₂, Journal of Nuclear Materials, 517 (2019) 286-295.
Boustani, E., et al., Developing a new target design for producing ⁹⁹Mo in a MTR reactor. Applied Radiation and Isotopes, 147 (2019) 121-128.
Fensin, M. L., Umbel, M., Testing actinide fission yield treatment in CINDER90 for use in MCNP6 burnup calculations, Progress in Nuclear Energy, 85 (2015) 719-728.
Glasstone, S., Sesonske, A. (1994). Nuclear reactor engineering: Reactor design basics, 4th Edition, Vol. 1 Chapman and Hall. Chapter 3.
Brewer, R., (2009) Criticality calculations with MCNP5: A primer, LA-UR-09-00380
International Atomic Energy Agency, Non-HEU Production Technologies for Molybdenum-99 and Technetium-99m, NF-T-5.4, Vienna, Austria, 2013: pp. 1-75.
Kittel, J. H., Paine, S. H. (1957) Effects of high burnup on natural uranium. Argonne National Laboratory, ANL-5539
Kostal, M., et al., Comparison of various hours living fission products for absolute power density determination in VVER-1000 mock up in LR-0 reactor, Applied Radiation and Isotopes, 105 (2015) 264-272.
Martin, P. M., et al., Behavior of fission gases in nuclear fuel: XAS characterization of Kr in UO₂, Journal of Nuclear Materials, 466 (2015) 379-392
Omar, H., Ghazi, N., Time dependent burn-up and fission products inventory calculations in the discharged fuel of the Syrian MNSR, Annals of Nuclear Energy, 3 (2011) 1698-1704
Pasqualini, E. E., Semi-homogeneous Reactor for ⁹⁹Mo Production: Conceptual Design, in RERTR 2011—33rd International Meeting on Reduced Enrichment for Research and Test Reactors. 2011: Marriott Santiago Hotel, Santiago, Chile. p. 10.
Pasqualini, E. E., et al., Irradiation Capsules with Suspended LEU UO₂ Particles for ⁹⁹Mo Production., in Mo-99 2016 Topical Meeting on Molybdenum-99 Technological Development. 2016: The Ritz-Carlton, St. Louis, Missouri. p. 14
Pelowitz, D. B., MCNP6 User's Manual, (2013), Los Alamos National Laboratory, LA-CP-13-00634.
Peryoga, Y., et al., Inherent Protection of Plutonium by Doping Minor Actinide in Thermal Neutron Spectra, Journal of Nuclear Science and Technology, 42(5) (2005) 442-450.
Peters, N. J., et al., Using Monte Carlo transport to accurately predict isotope production and activation analysis rates at the University of Missouri research reactor, Journal of Radioanalytical and Nuclear Chemistry, 282 (2009) 255-259.
Raposio, R., et al., Development of LEU-based targets for radiopharmaceutical manufacturing: A review. Applied Radiation and Isotopes, 148 (2019) 225-231
Rest, J., et al., Fission gas release from UO₂ nuclear fuel: A review. Journal of Nuclear Materials, 513 (2019) 310-345.
Smaga, J. A., et al., Electroplating fission-recoil barriers onto LEU-metal foils for ⁹⁹Mo-production targets. International Meeting on Reduced Enrichment for Research and Test Reactors (RERTR), Oct. 5-10, 1997, Jackson Hole, Wyoming, U.S.A.
Verbeke, J. M., et al., Fission reaction event yield algorithm, FREYA—for event-by-event simulation of fission, Computer Physics Communications, 191 (2015) 178-202.
Werner, C. J., “MCNP6.2 Release Notes”, Los Alamos National Laboratory, report LA-UR-18-20808 (2018).
Chakravarty, R., et al., Nanoceria-PAN Composite-Based Advanced Sorbent Material: A Major Step Forward in the Field of Clinical-Grade ⁶⁸Ge/⁶⁸Ga Generator, American Chemical Society, 2(7) (2010) 2069-2075, DOI: 10.1021/am100325s.
Lu, P., et al., Photochemical Deposition of Highly Dispersed Pt Nanoparticles on Porous CeO₂ Nanofibers for the Water-Gas Shift Reaction, Adv. Funct. Mater., 25(26) (2015) 4153-4162.
IAEA, IAEA Nuclear Energy Series. No. NW-T-1.14 Status and Trends in Spent Fuel and Radioactive Waste Management, 2018.
International Atomic Energy Agency, Basic Principles Objectives IAEA Nuclear Energy Series Non-HEU Production Technologies for Molybdenum-99 and Technetium-99m, 2013.
M. G. Ruiz et al., Synthesis and characterization of a mesoporous cerium oxide catalyst for the conversion of glycerol, J. Appl. Res. Technol., 1(6) (2018) 511-523.
I. Y. Kaplin et al., Template synthesis of porous ceria-based catalysts for environmental application, Molecules, 25(18) MDPI AG, 1 Sep. 2020.
K. Yoshikawa et al., Synthesis and analysis of CO₂ adsorbents based on cerium oxide, J. CO₂ Util., 8 (2014) 34-38.
R. Srivastava, Eco-friendly and morphologically-controlled synthesis of porous CeO₂ microstructure and its application in water purification, J. Colloid Interface Sci., 348(2) (2010) 600-607.
W. S\ddot{t}ober et al., Controlled growth of monodisperse silica spheres in the micron size range, J. Colloid Interface Sci., 26(1) (1968) 62-69.
X. Zhang et al., Hierarchically porous ceria with tunable pore structure from particle-stabilized foams, J. Eur. Ceram. Soc., 40(12) (2020) 4366-4372.
R. Raposio et al., Modelling of reusable target materials for the production of fission produced ⁹⁹Mo using MCNP6.2 and CINDER90, Appl. Radiat. Isot., 176 (2021) 109827.
A. M. Seydoux-Guillallallaume et al., Why natural monazite never becomes amorphous: Experimental evidence for alpha self-healing, Am. Mineral., 103(5) (2018) 824-827.
L. Nasdala et al., The absence of metamictisation in natural monazite, Sci. Rep., 10 (2020) 14676.
V. F. Sears, Neutron scattering lengths and cross sections, Neutron News, 3(3) (1992) 26-37.
S. Torrel and K. S. Krane, Neutron capture cross sections of ^{136,138,140,142}Ce and the decays of ¹³⁷Ce, Phys. Rev. C, 86(3) (2012) 34340.
A. T. Nelson et al., An Evaluation of the Thermophysical Properties of Stoichiometric CeO₂ in Comparison to UO₂ and PuO₂,” J. Am. Ceram. Soc., 97(11) (2014) 3652-3659.
J. Veliscek-Carolan et al., Effective Am(iii)/Eu(iii) separations using 2,6-bis(1,2,4-triazin-3-yl)pyridine (BTP) functionalised titania particles and hierarchically porous beads,” Chem. Commun., 51 (2015) 11433-11436.
R. Zhao et al., Synthesis of ordered mesoporous uranium dioxide by a nanocasting route, Radiochim. Acta, 104(8) (2016) 549-553.

1. A method of manufacturing particles of UO₂ for a porous matrix of a target for use in the manufacture of ⁹⁹Mo, the method comprising:
infiltrating a solution of uranyl nitrate into a polymer template;
either (i) introducing an alkali chemical to the uranyl nitrate infiltrated polymer template, causing precipitation of uranium oxide and uranium hydroxide, and converting the uranium oxide and uranium hydroxide to U₃O₈ and concurrently removing the polymer template, by heating the infiltrated polymer template; or (ii) converting the uranyl nitrate to U₃O₈ and concurrently removing the polymer template, by heating the infiltrated polymer template; and
reducing the U₃O₈ to UO₂ via heating in a reducing atmosphere.

2. A method as claimed in claim 1, comprising heating the infiltrated polymer template to a maximum temperature of 400° C. or 600° C.

3. A method as claimed in claim 1, comprising reducing the U₃O₈ to UO₂ at a maximum temperature of 1000° C.

4. A method as claimed in claim 1, comprising manufacturing particles of CeO₂ for the porous matrix, the method comprising:
infiltrating a solution of a cerium salt into a further polymer template; and
either (i) introducing an alkali chemical to the infiltrated further polymer template, causing precipitation of cerium oxide and cerium hydroxide; and converting the cerium oxide/hydroxide to CeO₂ and concurrently removing the further polymer template, by heating the infiltrated further polymer template; or (ii) converting the cerium salt to CeO₂ and concurrently removing the further polymer template, by heating the infiltrated further polymer template.

5. A method as claimed in claim 4, wherein the further polymer template is in the form of polyacrylonitrile (PAN) beads.

6. A method as claimed in claim 4, comprising forming the particles of UO₂ and the particles of CeO₂ sequentially, and mixing the particles of UO₂ and the particles of CeO₂.

7. A method as claimed in claim 4, comprising controlling a ratio of cerium and uranium by controlling the amount or amounts of infiltration of the cerium salt and uranyl nitrate.

8. A method of manufacturing particles of UO₂ and CeO₂ for a porous matrix of a target for use in the manufacture of ⁹⁹Mo, the method comprising:
infiltrating a solution of uranyl nitrate and cerium nitrate into a polymer template;
precipitating uranium oxide and uranium hydroxide and cerium oxide and cerium hydroxide by introducing an alkali chemical to the uranyl nitrate and cerium nitrate infiltrated template;
converting the uranium oxide and uranium hydroxide, and cerium oxide and cerium hydroxide, to U₃O₈ and CeO₂ respectively and concurrently removing the template, by heating the infiltrated template; and
reducing the U₃O₈ and CeO₂ to UₓCe₁₋ₓO₂ via heating in a reducing atmosphere, where x is the initial molar mixing ratio of uranium and cerium.

9. A method as claimed in claim 8, comprising controlling a ratio of cerium and uranium by controlling the amount or amounts of infiltration of the cerium salt and uranyl nitrate.

10. A method as claimed in claim 1, wherein the polymer template is in the form of polyacrylonitrile (PAN) beads.

11. A method as claimed in claim 1, wherein the reducing atmosphere is approximately 3.5% hydrogen in nitrogen gas.

12. A method of manufacturing particles of UO₂ for a porous matrix of a target for use in the manufacture of ⁹⁹Mo, the method comprising:
creating a template comprising polymer beads;
infiltrating the polymer beads of the template with UO₂; and
calcinating the infiltrated polymer beads of the template.

13. A method as claimed in claim 12, comprising:
infiltrating the polymer beads additionally with cerium, such that the polymer beads are infiltrated with both UO₂ and cerium.

14. A method as claimed in claim 13, wherein the cerium for infiltration is in the form of a cerium salt.

15. A method as claimed in claim 13, comprising selecting the ratio of infiltrated cerium and uranium and the enrichment of the uranium so as to provide a desired ultimate molar ratio of ²³⁵U to Ce and ²³⁸U.

16. A method as claimed in claim 12, wherein the polymer beads are polyacrylonitrile (PAN) beads.

17. A particle for a porous matrix of a target for use in the manufacture of ⁹⁹Mo, manufactured with the method of claim 1.

18. A porous matrix of a target for use in the manufacture of ⁹⁹Mo, the porous matrix comprising a plurality of particles manufactured with the method of claim 1.

19. A target for use in the manufacture of ⁹⁹Mo, comprising the porous matrix of claim 18.
